(19) United States
(12) Patent Application Publication
(10) Pub. No.: US 2024/0080730 A1
(43) Pub. Date: Mar. 7, 2024

(54) METHOD AND APPARATUS FOR RELAY SELECTION

(71) Applicant: Telefonaktiebolaget LM Ericsson (publ), Stockholm (SE)

(72) Inventors: Zhang ZHANG, BEIJING (CN); Antonino ORSINO, KIRKKONUMMI (FI); Min WANG, LULEÅ (SE); Xhang FU, STOCKHOLM (SE)

(73) Assignee: Telefonaktiebolaget LM Ericsson (publ), Stockholm (SE)

(21) Appl. No.: 18/268,971

(22) PCT Filed: Nov. 26, 2021
(86) PCT No.: PCT/CN2021/133614

§ 371 Date: Jun. 21, 2023

(30) Foreign Application Priority Data
Dec. 22, 2020 (WO) PCT/CN2022/138426
Jan. 8, 2021 (WO) PCT/CN2021/070844

(51) Int. Cl. H04W 36/00

(52) U.S. Cl. CPC H04W 36/03; H04W 88/04

(57) ABSTRACT

Various embodiments of the present disclosure provide a method for relay (re) selection. The method which may be performed by a first terminal device comprises generating a message targeting at least a second terminal device. In accordance with an exemplary embodiment, the message may include an indicator used to determine which of the first terminal device and the second terminal device is to perform relay selection or reselection. The method further comprises transmitting the message towards the second terminal device.

### FIELD OF THE INVENTION

The present disclosure generally relates to communication networks, and more specifically, to a method and apparatus for relay selection.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the evolution of wireless communication, a requirement for supporting device-to-device (D2D) communication features in various applications is proposed. An extension for the D2D work may consist of supporting vehicle-to-everything (V2X) communication, which may include any combination of direct communications among vehicles, pedestrians and infrastructure. Wireless communication networks such as fourth generation (4G)/long term evolution (LTE) and fifth generation (5G)/new radio (NR) networks may be expected to use V2X services and support communication for V2X capable user equipment (UE).

Sidelink transmissions over NR are specified in the 3rd Generation Partnership Project (3GPP) in Release 16, including enhancements of Proximity-based Services (ProSe) specified for LTE. Four new enhancements are particularly introduced to NR sidelink transmissions as follows:
Support for unicast and groupcast transmissions is added in NR sidelink. For unicast and groupcast, a Physical Sidelink Feedback Channel (PSFCH) is introduced for a receiver UE to reply a decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also leads to a new design of Physical Sidelink Common Control Channel (PSCCH).
To achieve a high connection density, congestion control and thus QoS management are supported in NR sidelink transmissions.

To enable the above enhancements, new physical channels and reference signals are introduced in NR:
Physical Sidelink Shared Channel (PSSCH), a sidelink version of Physical Downlink Shared Channel (PDSCH): The PSSCH is transmitted by a sidelink transmitter UE, and conveys sidelink transmission data, System Information Blocks (SIBs) for Radio Resource Control (RRC) configuration, and a part of Sidelink Control Information (SCI), a sidelink version of Downlink Control Information (DCI).
PSFCH, a sidelink version of Physical Uplink Control Channel (PUCCH): The PSFCH is transmitted by a sidelink receiver UE for unicast and groupcast, and conveys 1-bit information over 1 Resource Block (RB) for a Hybrid Automatic Repeat reQeust (HARQ) acknowledgement (ACK) or a negative ACK (NACK). In addition, Channel State Information (CSI) is carried in a Medium Access Control (MAC) Control Element (CE) over the PSSCH instead of the PSFCH.
PSCCH, a sidelink version of Physical Downlink Control Channel (PDCCH): When traffic to be sent to a receiver UE arrives at a transmitter UE, the transmitter UE should first send the PSCCH, which conveys a part of SCI to be decoded by any UE for the channel sensing purpose, including reserved time-frequency resources for transmissions, DeModulation Reference Signal (DMRS) pattern, and antenna port, etc.
Sidelink Primary/Secondary Synchronization Signal (S-PSS/S-SSS): Similar to downlink transmissions in NR, in sidelink transmissions, S-PSS and S-SSS are supported. Through detecting the S-PSS and S-SSS, a UE is able to identify a Sidelink Synchronization Identity (SSID) from the UE sending the S-PSS/S-SSS. The UE is therefore able to know the characteristics of the transmitter UE from the S-PSS/S-SSS. A series of processes of acquiring timing and frequency synchronization together with SSIDs of UEs is called initial cell search. Note that the UE sending the S-PSS/S-SSS may not be necessarily involved in sidelink transmissions, and a node (e.g., UE, evolved NodeB (eNB), or (next) generation NodeB (gNB)) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a Synchronization Signal/PSBCH Block (SSB). The SSB has the same numerology as PSCCH/PSSCH on the carrier, and an SSB should be transmitted within the bandwidth of the configured BWP. The PSBCH conveys information related to synchronization, such as the Direct Frame Number (DFN), an indication of the slot and symbol level time resources for sidelink transmissions, an in-coverage indicator, etc. The SSB is transmitted periodically at every 160 ms.
DMRS, Phase Tracking Reference Signal (PT-RS), Channel State Information Reference Signal (CSI-RS): These physical reference signals supported by NR downlink/uplink transmissions are also adopted by sidelink transmissions. Similarly, the PT-RS is only applicable for Frequency Range 2 (FR2) transmission.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In a communication network supporting V2X services, a source UE may communicate with a target UE directly or via one or more UE-to-UE relay UEs. If there are multiple UE-to-UE relay UEs can be used to reach the target UE, a relay (re)selection may be performed to establish a communication path between the source UE and the target UE. According to the existing solution, a UE sending a relay (re)selection request may assume that its peer UE will perform relay (re)selection. However, there may be a collision in relay (re)selection if both UEs perform relay (re)selection and different relay UEs are selected by the two UEs, or relay (re)selection may not be performed at all if both UEs assume that the peer UE will perform relay UE (re)selection. Therefore, it may be desirable to implement relay (re)selection in a more efficient way.

Various exemplary embodiments of the present disclosure propose a solution for relay (re)selection, which can enable a UE to determine whether to perform relay (re)selection, e.g., according to a (pre)configured or negotiated criterion, so as to avoid a collision due to multiple UEs triggering simultaneous relay (re)selection.

It can be appreciated that the “remote UE” described in this document may refer to a UE that may communicate with a relay UE e.g. via PC5/sidelink (SL) interface, and/or communicate with a network node e.g. via Uu interface. As an example, the remote UE may be a 5G proximity-based services (ProSe) enabled UE that may communicate with a network (NW) via a ProSe 5G UE-to-NW relay UE. As another example, the remote UE may be a 5G ProSe enabled UE that may communicate with another UE via a ProSe 5G UE-to-UE relay UE.

It can be appreciated that the “relay UE” described in this document may refer to “UE-to-NW relay UE” or “UE-to-UE relay UE”. As an example, the relay UE may be a 5G ProSe enabled UE that is capable of supporting connectivity to the NW and/or other UE(s) for the remote UE.

It can be appreciated that the “UE-to-UE relay UE” described in this document may also be referred to as “UE-to-UE relay”, “relay UE” or “relay”. Thus, the terms “UE-to-UE relay UE”, “UE-to-UE relay”, “relay UE” and “relay” may be used interchangeably in this document.

It can be appreciated that terms “relay selection” and “relay UE selection” described in this document may refer to initial selection of a relay UE to establish a relay path between a source UE and a target UE, or reselection of a relay UE to switch a relay path between a source UE and a target UE.

It also can be appreciated that terms “relay path” or “end to end (E2E) connection” described in this document may be used to stand for an end to end connection containing multiple PC5 links/hops.

According to a first aspect of the present disclosure, there is provided a method performed by a first terminal device such as a UE. The method comprises: generating a message targeting at least a second terminal device. The message may include an indicator used to determine which of the first terminal device and the second terminal device is to perform relay selection or reselection. In accordance with an exemplary embodiment, the method further comprises: transmitting the message towards the second terminal device.

In accordance with an exemplary embodiment, the message may be transmitted from the first terminal device to the second terminal device via at least a third terminal device capable of relaying.

In accordance with an exemplary embodiment, the message may be a discovery or link establishment request message, or a relay selection or reselection request message.

In accordance with an exemplary embodiment, the indicator included in the message may be a time stamp representing a time when the first terminal device requests the relay selection or reselection.

In accordance with an exemplary embodiment, the time when the first terminal device requests the relay selection or reselection may be a time when the message is generated or transmitted by the first terminal device.

In accordance with an exemplary embodiment, when the time stamp indicates that the first terminal device requests the relay selection or reselection earlier than the second terminal device, it may be determined that the second terminal device is to perform the relay selection or reselection.

In accordance with an exemplary embodiment, the indicator included in the message may be an identifier (ID) of the first terminal device.

In accordance with an exemplary embodiment, when the identifier of the first terminal device is larger than an identifier of the second terminal device, it may be determined that the second terminal device is to perform the relay selection or reselection.

In accordance with an exemplary embodiment, when the identifier of the first terminal device is smaller than an identifier of the second terminal device, it may be determined that the second terminal device is to perform the relay selection or reselection.

In accordance with an exemplary embodiment, the method according to the first aspect of the present disclosure may further comprise: receiving a response to the message from the second terminal device. The response to the message may include a result of the relay selection or reselection performed by the second terminal device.

In accordance with an exemplary embodiment, the method according to the first aspect of the present disclosure may further comprise: starting a timer, in response to transmitting the message towards the second terminal device.

In accordance with an exemplary embodiment, the timer may be configurable for each peer device of the first terminal device.

In accordance with an exemplary embodiment, when the response to the message is not received by the first terminal device until the timer is expired, the method according to the first aspect of the present disclosure may further comprise: performing the relay selection or reselection; and transmitting a result of the relay selection or reselection performed by the first terminal device to the second terminal device.

In accordance with an exemplary embodiment, the method according to the first aspect of the present disclosure may further comprise: performing a negotiation with the second terminal device to determine a criterion for determining which of the first terminal device and the second terminal device is to perform the relay selection or reselection.

In accordance with an exemplary embodiment, the criterion may be a time stamp based criterion or a device identifier based criterion.

In accordance with an exemplary embodiment, the negotiation between the first terminal device and the second terminal device may be performed by one or more of:
PC5-radio resource control (PC5-RRC) signaling;
a control element for media access control (MAC CE);
a control protocol data unit (PDU); and
physical layer signaling.

In accordance with an exemplary embodiment, the method according to the first aspect of the present disclosure may further comprise: transmitting a notification to one or more devices on a path between the first terminal device and the second terminal device. The one or more devices may include at least the second terminal device, and the notification may indicate that the first terminal device triggers a relay selection or reselection event.

In accordance with an exemplary embodiment, the method according to the first aspect of the present disclosure may further comprise: handling the relay selection or reselection event during a time period. The one or more devices may not trigger the relay selection or reselection event during the time period.

In accordance with an exemplary embodiment, the relay selection or reselection event may be triggered by the first terminal device according to a threshold. In an embodiment, the threshold may be different from respective thresholds configured for the one or more devices to trigger the relay selection or reselection event.

In accordance with an exemplary embodiment, the method according to the first aspect of the present disclosure may further comprise: receiving configuration information for the relay selection or reselection from a base station and/or a fourth terminal device (e.g., a UE which may be able to control communication of the first terminal device, etc.).

According to a second aspect of the present disclosure, there is provided an apparatus which may be implemented as a first terminal device. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a first terminal device. The apparatus may comprise a generating unit and a transmitting unit. In accordance with some exemplary embodiments, the generating unit may be operable to carry out at least the generating step of the method according to the first aspect of the present disclosure. The transmitting unit may be operable to carry out at least the transmitting step of the method according to the first aspect of the present disclosure.

According to a fifth aspect of the present disclosure, there is provided a method performed by a second terminal device such as a UE. The method comprises: receiving a message targeting at least the second terminal device from a first terminal device. The message may include an indicator used to determine which of the first terminal device and the second terminal device is to perform relay selection or reselection. In accordance with an exemplary embodiment, the method further comprises: determining whether to perform the relay selection or reselection, according to the indicator.

In accordance with an exemplary embodiment, the message (e.g., a discovery or link establishment request message, or a relay selection or reselection request message, etc.) may be received by the second terminal device from the first terminal device via at least a third terminal device capable of relaying.

In accordance with an exemplary embodiment, the message and the indicator described according to the fifth aspect of the present disclosure may correspond to the message and the indicator described according to the first aspect of the present disclosure, respectively.

In accordance with an exemplary embodiment, when the indicator (e.g., a time stamp, etc.) included in the message indicates that the first terminal device requests the relay selection or reselection earlier than the second terminal device, the second terminal device may determine to perform the relay selection or reselection.

In accordance with an exemplary embodiment, when the indicator such as an identifier of the first terminal device included in the message is larger than an identifier of the second terminal device, the second terminal device may determine to perform the relay selection or reselection.

In accordance with an exemplary embodiment, when the identifier of the first terminal device is smaller than an identifier of the second terminal device, the second terminal device may determine to perform the relay selection or reselection.

In accordance with an exemplary embodiment, the method according to the fifth aspect of the present disclosure may further comprise: transmitting a response to the message to the first terminal device. The response to the message may include a result of the relay selection or reselection performed by the second terminal device.

In accordance with an exemplary embodiment, when the response to the message is not received by the first terminal device until a timer is expired, the method according to the fifth aspect of the present disclosure may further comprise: receiving, from the first terminal device, a result of the relay selection or reselection performed by the first terminal device.

In accordance with an exemplary embodiment, the timer may be started by the first terminal device when the message is transmitted towards the second terminal device by the first terminal device.

In accordance with an exemplary embodiment, the method according to the fifth aspect of the present disclosure may further comprise: performing a negotiation with the first terminal device to determine a criterion for determining which of the first terminal device and the second terminal device is to perform the relay selection or reselection.

In accordance with an exemplary embodiment, the negotiation and the criterion described according to the fifth aspect of the present disclosure may correspond to the negotiation and the criterion described according to the first aspect of the present disclosure, respectively.

In accordance with an exemplary embodiment, the method according to the fifth aspect of the present disclosure may further comprise: receiving a notification transmitted by the first terminal device to one or more devices on a path between the first terminal device and the second terminal device. The one or more devices may include at least the second terminal device, and the notification may indicate that the first terminal device triggers a relay selection or reselection event.

In accordance with an exemplary embodiment, the method according to the fifth aspect of the present disclosure may further comprise: receiving configuration information for the relay selection or reselection from a base station and/or a fourth terminal device (e.g., a UE which may be able to control communication of the second terminal device, etc.).

According to a sixth aspect of the present disclosure, there is provided an apparatus which may be implemented as a second terminal device. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a second terminal device. The apparatus may comprise a receiving unit and a determining unit. In accordance with some exemplary embodiments, the receiving unit may be operable to carry out at least the receiving step of the method according to the fifth aspect of the present disclosure. The determining unit may be operable to carry out at least the determining step of the method according to the fifth aspect of the present disclosure.

According to a ninth aspect of the present disclosure, there is provided a method performed by a third terminal device such as a UE. The method comprises: receiving a first message targeting at least a second terminal device from a first terminal device. The first message may include a first indicator used to determine which of the first terminal device and the second terminal device is to perform relay selection or reselection. In accordance with an exemplary embodiment, the method further comprises: determining whether to forward the first message towards the second terminal device, based at least in part on the first indicator.

In accordance with an exemplary embodiment, the first message and the first indicator described according to the ninth aspect of the present disclosure may correspond to the message and the indicator described according to the first aspect of the present disclosure, respectively.

In accordance with an exemplary embodiment, the first indicator may be a first time stamp representing a time when the first terminal device requests the relay selection or reselection.

In accordance with an exemplary embodiment, the method according to the ninth aspect of the present disclosure may further comprise: receiving a second message targeting at least the first terminal device from the second terminal device. The second message may include a second time stamp representing a time when the second terminal device requests the relay selection or reselection.

In accordance with an exemplary embodiment, the method according to the ninth aspect of the present disclosure may further comprise: comparing the first time stamp and the second time stamp to determine whether the first terminal device requests the relay selection or reselection earlier than the second terminal device.

In accordance with an exemplary embodiment, when the first terminal device requests the relay selection or reselection earlier than the second terminal device, the third terminal device may determine to forward the first message towards the second terminal device.

In accordance with an exemplary embodiment, when the first terminal device requests the relay selection or reselection later than the second terminal device, the third terminal device may determine not to forward the first message towards the second terminal device.

In accordance with an exemplary embodiment, the first indicator may be an identifier of the first terminal device.

In accordance with an exemplary embodiment, the method according to the ninth aspect of the present disclosure may further comprise: receiving a second message targeting at least the first terminal device from the second terminal device. The second message may include an identifier of the second terminal device.

In accordance with an exemplary embodiment, the method according to the ninth aspect of the present disclosure may further comprise: comparing the identifiers of the first terminal device and the second terminal devices.

In accordance with an exemplary embodiment, when the identifier of the first terminal device is larger than the identifier of the second terminal device, the third terminal device may determine to forward the first message towards the second terminal device.

In accordance with an exemplary embodiment, when the identifier of the first terminal device is smaller than the identifier of the second terminal device, the third terminal device may determine not to forward the first message towards the second terminal device.

In accordance with an exemplary embodiment, when the identifier of the first terminal device is smaller than the identifier of the second terminal device, the third terminal device may determine to forward the first message towards the second terminal device.

In accordance with an exemplary embodiment, when the identifier of the first terminal device is larger than the identifier of the second terminal device, the third terminal device may determine not to forward the first message towards the second terminal device.

In accordance with an exemplary embodiment, the method according to the ninth aspect of the present disclosure may further comprise: forwarding the first message towards the second terminal device, without forwarding the second message towards the first terminal device.

In accordance with an exemplary embodiment, the method according to the ninth aspect of the present disclosure may further comprise: receiving a response to the first message from the second terminal device; and forwarding the response to the first message to the first terminal device. The response to the first message may include a result of the relay selection or reselection performed by the second terminal device.

In accordance with an exemplary embodiment, the method according to the ninth aspect of the present disclosure may further comprise: forwarding the second message towards the first terminal device, without forwarding the first message towards to the second terminal device.

In accordance with an exemplary embodiment, the method according to the ninth aspect of the present disclosure may further comprise: receiving a response to the second message from the first terminal device; and forwarding the response to the second message to the second terminal device. The response to the second message may include a result of the relay selection or reselection performed by the first terminal device.

In accordance with an exemplary embodiment, the first message may target two or more terminal devices including the second terminal device. According to an embodiment, when the first terminal device requests the relay selection or reselection later than the two or more terminal devices, the third terminal device may determine not to forward the first message towards the two or more terminal devices. According to another embodiment, when an identifier of the first terminal device is smaller than identifiers of the two or more terminal devices, the third terminal device may determine not to forward the first message towards the two or more terminal devices. According to a further embodiment, when an identifier of the first terminal device is larger than identifiers of the two or more terminal devices, the third terminal device may determine not to forward the first message towards the two or more terminal devices.

In accordance with an exemplary embodiment, the third terminal device may always forward a message including no time stamp and/or target user information.

In accordance with an exemplary embodiment, the method according to the ninth aspect of the present disclosure may further comprise: receiving a notification transmitted by the first terminal device to one or more devices on a path between the first terminal device and the second terminal device. The one or more devices may include at least the second terminal device and the third terminal device, and the notification may indicate that the first terminal device triggers a relay selection or reselection event.

In accordance with an exemplary embodiment, the method according to the ninth aspect of the present disclosure may further comprise: receiving configuration information for the relay selection or reselection from a base station and/or a fourth terminal device (e.g., a UE which may be able to control communication of the third terminal device, etc.).

In accordance with an exemplary embodiment, the first message may be a discovery or link establishment request message, or a relay selection or reselection request message.

In accordance with an exemplary embodiment, the second message may be a discovery or link establishment request message, or a relay selection or reselection request message.

According to a tenth aspect of the present disclosure, there is provided an apparatus which may be implemented as a third terminal device. The apparatus may comprise one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a third terminal device. The apparatus may comprise a receiving unit and a determining unit. In accordance with some exemplary embodiments, the receiving unit may be operable to carry out at least the receiving step of the method according to the ninth aspect of the present disclosure. The determining unit may be operable to carry out at least the determining step of the method according to the ninth aspect of the present disclosure.

According to a thirteenth aspect of the present disclosure, there is provided a method performed by a communication device such as a network node or a terminal device. The method comprises: determining configuration information for relay selection or reselection. In accordance with an exemplary embodiment, the method further comprises: transmitting the configuration information to a first terminal device and/or a second terminal device, to facilitate determining which of the first terminal device and the second terminal device to perform the relay selection or reselection.

In accordance with an exemplary embodiment, the configuration information may indicate a criterion (e.g., a time stamp based criterion or a device identifier based criterion, etc.) for determining which of the first terminal device and the second terminal device is to perform the relay selection or reselection.

In accordance with an exemplary embodiment, the configuration information may indicate one or more of:
a timer configuration based on waiting time for a response to a relay selection or reselection request;
a forwarding configuration for one or more relay selection or reselection requests; and
a trigger configuration for a relay selection or reselection event.

In accordance with an exemplary embodiment, the method according to the thirteenth aspect of the present disclosure may further comprise: transmitting the configuration information to a third terminal device. The first terminal device may communicate with the second terminal device via the third terminal device.

In accordance with an exemplary embodiment, the communication device may be a base station or a fourth terminal device (e.g., a UE capable of controlling at least one of the first terminal device, the second terminal device and the third terminal device, etc.).

According to a fourteenth aspect of the present disclosure, there is provided an apparatus which may be implemented as a communication device. The apparatus may comprise one or more processors and one or more memories storing computer program codes. The one or more memories and the computer program codes may be configured to, with the one or more processors, cause the apparatus at least to perform any step of the method according to the thirteenth aspect of the present disclosure.

According to a fifteenth aspect of the present disclosure, there is provided a computer-readable medium having computer program codes embodied thereon which, when executed on a computer, cause the computer to perform any step of the method according to the thirteenth aspect of the present disclosure.

According to a sixteenth aspect of the present disclosure, there is provided an apparatus which may be implemented as a communication device. The apparatus may comprise a determining unit and a transmitting unit. In accordance with some exemplary embodiments, the determining unit may be operable to carry out at least the determining step of the method according to the thirteenth aspect of the present disclosure. The transmitting unit may be operable to carry out at least the transmitting step of the method according to the thirteenth aspect of the present disclosure.

In addition to the solutions for relay (re)selection according to the foregoing aspects of the present disclosure, for UE-to-UE (U2U) relay, various mechanisms are also proposed for relay UE selection and reselection, which may enable an early warning for the link to be provided by any UE that is capable of detecting a potential failure of the link.

An early warning threshold of radio channel quality is preconfigured or configured for the UE so that the UE can detect that a PC5 link may become bad in an early stage. In that case, the UE may negotiate with other UEs on the relay path (e.g., target UE) on selection of a new relay UE. If the negotiation succeeds, the relay path is restored from potential link failures. Otherwise, if the negotiation fails, the UE has to declare a radio link failure (RLF) for the link and initiate a discovery procedure and decides a new relay UE by itself.

Another threshold of radio channel quality in terms of metrics, such as reference signal received power (RSRP), reference signal received quality (RSRQ), received signal strength indicator (RSSI), signal to interference plus noise ratio (SINR), signal to interference ratio (SIR), channel busy ratio, etc., is configured/preconfigured to a UE (i.e., source UE, relay UE, or target UE) for indicating that the UE's PC5 unicast link has been too bad. In case the threshold is fulfilled (e.g., measured radio quality is less than the threshold for a configured time period), the UE determines that the link has been too bad. The UE may declare RLF for the link. Compared to the early warning threshold, this threshold may be set as a lower value.

In the case that the UE has multiple PC5 unicast links, the UE may be configure/preconfigured with a separate threshold per link.

In the case that the UE has multiple services using side link communication, the UE may be configure/preconfigured with separate threshold per service/application.

Alternatively, the UE does not declare RLF for the link. The UE just initiates the U2U discovery procedure in proximity.

According to a seventeenth aspect of the present disclosure, a method implemented by a fifth terminal device is provided. The method comprises: declaring an early warning event for a link associated with the fifth terminal device based on a first threshold of radio channel quality of the link; and transmitting a first message about the early warning event to other terminal devices in the link.

In an alternative embodiment of the seventeenth aspect, the first threshold may be preconfigured or configured by a control node for the fifth terminal device.

In a further alternative embodiment of the seventeenth aspect, when the fifth terminal device is associated with more than one link, the first threshold may be configured per link.

In another further alternative embodiment of the seventeenth aspect, when the fifth terminal device is one of two remote terminal devices associated with the link, the method may further comprise triggering a first relay reselection.

In another alternative embodiment of the seventeenth aspect, upon declaration of an RLF, when the fifth terminal device is a remote terminal device, the method may further comprise triggering a second relay reselection.

In an alternative embodiment of the seventeenth aspect, the method may further comprise: declaring an RLF for the link based on a second threshold of radio channel quality of the link. The second threshold may be lower than the first threshold.

In a further alternative embodiment of the seventeenth aspect, the second threshold may be preconfigured or configured by a control node for the fifth terminal device.

According to an eighteenth aspect of the present disclosure, a method implemented by a sixth terminal device is provided. The method comprises: receiving a first message about the early warning event from a fifth terminal device. The early warning event is declared by the fifth terminal device for a link associated with the fifth terminal device based on a first threshold of radio channel quality of the link.

According to a nineteenth aspect of the present disclosure, a method implemented by a control node is provided. The method comprises: determining a first threshold of radio channel quality of a link for a fifth terminal device. The first threshold is associated with an early warning event for the link.

According to a twentieth aspect of the present disclosure, a fifth terminal device is provided. The fifth terminal device comprises a processor and a memory communicatively coupled to the processor. The memory is adapted to store instructions which, when executed by the processor, cause the fifth terminal device to perform operations of the method according to the above seventeenth aspect.

According to a twenty-first aspect of the present disclosure, a fifth terminal device is provided. The fifth terminal device comprises at least a declaration unit and a transmission unit. The declaration unit is adapted to declare an early warning event for a link associated with the fifth terminal device based on a first threshold of radio channel quality of the link. The transmission unit is adapted to transmit a first message about the early warning event to other terminal devices in the link.

According to a twenty-second aspect of the present disclosure, a sixth terminal device is provided. The sixth terminal device comprises a processor and a memory communicatively coupled to the processor. The memory is adapted to store instructions which, when executed by the processor, cause the sixth terminal device to perform operations of the method according to the above eighteenth aspect.

According to a twenty-third aspect of the present disclosure, a sixth terminal device is provided. The sixth terminal device comprises at least a receiving unit. The receiving unit is adapted to receive a first message about an early warning event from a fifth terminal device. The early warning event is declared by the fifth terminal device for a link associated with the fifth terminal device based on a first threshold of radio channel quality of the link.

According to a twenty-fourth aspect of the present disclosure, a control node is provided. The control node comprises a processor and a memory communicatively coupled to the processor. The memory is adapted to store instructions which, when executed by the processor, cause the control node to perform operations of the method according to the above nineteenth aspect.

According to a twenty-fifth aspect of the present disclosure, a control node is provided. The control node comprises at least a determination unit. The determination unit is adapted to determine a first threshold of radio channel quality of a link for a fifth terminal device. The first threshold is associated with an early warning event for the link.

According to a twenty-sixth aspect of the present disclosure, a wireless communication system is provided. The wireless communication system comprises: a fifth terminal device according to the above twentieth or twenty-first aspect; a sixth terminal device according to the above twenty-second or twenty-third aspect communicating with at least the fifth terminal device; and a control node according to the above twenty-fourth or twenty-fifth aspect communicating with at least the fifth terminal device and the sixth terminal device.

According to a twenty-seventh aspect of the present disclosure, a non-transitory computer readable medium having a computer program stored thereon is provided. When the computer program is executed by a set of one or more processors of the fifth terminal device, the computer program causes the fifth terminal device to perform operations of the method according to the above seventeenth aspect.

According to a twenty-eighth aspect of the present disclosure, a non-transitory computer readable medium having a computer program stored thereon is provided. When the computer program is executed by a set of one or more processors of the sixth terminal device, the computer program causes the sixth terminal device to perform operations of the method according to the above eighteenth aspect.

According to a twenty-ninth aspect of the present disclosure, a non-transitory computer readable medium having a computer program stored thereon is provided. When the computer program is executed by a set of one or more processors of the control node, the computer program causes the control node to perform operations of the method according to the above nineteenth aspect.

According to a thirtieth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the thirteenth or nineteenth aspect of the present disclosure.

According to a thirty-first aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the thirteenth or nineteenth aspect of the present disclosure.

According to a thirty-second aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first, fifth, ninth, thirteenth, seventeenth, eighteenth or nineteenth aspect of the present disclosure.

According to a thirty-third aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first, fifth, ninth, thirteenth, seventeenth, eighteenth or nineteenth aspect of the present disclosure.

According to a thirty-fourth aspect of the present disclosure, there is provided a method implemented in a communication system which may include a host computer, a base station and a UE. The method may comprise, at the host computer, receiving user data transmitted to the base station from the UE which may perform any step of the method according to the first, fifth, ninth, thirteenth, seventeenth, eighteenth or nineteenth aspect of the present disclosure.

According to a thirty-fifth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first, fifth, ninth. thirteenth, seventeenth, eighteenth or nineteenth aspect of the present disclosure.

According to a thirty-sixth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the thirteenth or nineteenth aspect of the present disclosure.

According to a thirty-seventh aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the thirteenth or nineteenth aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIGS. 1A-1B are diagrams illustrating exemplary protocol stacks for a Layer-2 (L2) UE-to-UE relay according to some embodiments of the present disclosure;

FIG. 2 is a diagram illustrating an exemplary protocol stack for a Layer-3 (L3) UE-to-UE relay according to an embodiment of the present disclosure;

FIGS. 3A-3C are diagrams illustrating exemplary UE-to-UE relay selection according to some embodiments of the present disclosure;

FIGS. 4A-4G are flowcharts illustrating various methods according to some embodiments of the present disclosure;

FIG. 5 is a block diagram illustrating an apparatus according to some embodiments of the present disclosure;

FIGS. 6A-6J are block diagrams illustrating various apparatuses according to some embodiments of the present disclosure;

FIG. 6K is a block diagram illustrating a wireless communication system according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

The following detailed description describes methods, apparatuses and devices for flexible terminal device-to-terminal device relay (re)selection. In the following detailed description, numerous specific details such as logic implementations, types and interrelationships of system components, etc. are set forth in order to provide a more thorough understanding of the present disclosure. It should be appreciated, however, by one skilled in the art that the present disclosure may be practiced without such specific details. In other instances, control structures, circuits and instruction sequences have not been shown in detail in order not to obscure the present disclosure. Those of ordinary skill in the art, with the included descriptions, will be able to implement appropriate functionality without undue experimentation.

References in the specification to “one embodiment”, “an embodiment”, “an example embodiment” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure.

In the following detailed description and claims, the terms “coupled” and “connected” along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other forms of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interfaces to establish network connections (to transmit and/or receive code and/or data using propagating signals) with other electronic devices. One or more parts of an embodiment of the present disclosure may be implemented using different combinations of software, firmware, and/or hardware.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

3GPP specifies the LTE D2D technology, also known as ProSe (Proximity Services) in Release 12 and Release 13 of LTE. Later in Release 14 and Release 15, LTE V2X related enhancements targeting the specific characteristics of vehicular communications are specified. 3GPP has started a new work item (WI) within the scope of Release 16 to develop a NR version of V2X communications. The NR V2X mainly targets advanced V2X services, which may be categorized into four use case groups: vehicles platooning, extended sensors, advanced driving and remote driving. The advanced V2X services may require the enhanced NR system and new NR sidelink framework to meet the stringent requirements in terms of latency and reliability. The NR V2X system may also expect to have higher system capacity and better coverage and to allow for an easy extension to support the future development of further advanced V2X services and other services.

Given the targeted services by NR V2X, it is commonly recognized that groupcast/multicast and unicast transmissions may be desired, in which the intended receiver of a message may consist of only a subset of the vehicles in proximity to the transmitter (groupcast) or of a single vehicle (unicast). For example, in the platooning service, there are certain messages that are only of interest of the members of the platoon, making the members of the platoon a natural groupcast. In another example, the see-through use case most likely involves only a pair of vehicles, for which unicast transmissions may naturally fit. Therefore, NR sidelink can support broadcast (as in LTE), groupcast and unicast transmissions. Furthermore, NR sidelink may be designed in such a way that its operation is possible with and without network coverage and with varying degrees of interaction between the UEs and the network (NW), including support for standalone, network-less operation.

In 3GPP Release 17, discussions are being taken place and national security and public safety (NSPS) is considered to be one of important use cases, which can benefit from the already developed NR sidelink features in Release 16. Therefore, it is most likely that 3GPP may specify enhancements related to NSPS use case taking NR Release 16 sidelink as a baseline. Besides, in some scenarios, NSPS services may need to operate with partial or without NW coverage, such as indoor firefighting, forest firefighting, earthquake rescue, sea rescue, etc., where the infrastructure may be (partially) destroyed or not available. Therefore, coverage extension may be a crucial enabler for NSPS, for both NSPS services communicated between a UE and a cellular NW and communicated between UEs over sidelink. In Release 17, a new study item description (SID) on NR sidelink relay (RP-193253) is launched, which aims to further explore coverage extension for sidelink-based communication, including both UE-to-UE relay for cellular coverage extension and UE-to-UE relay for sidelink coverage extension.

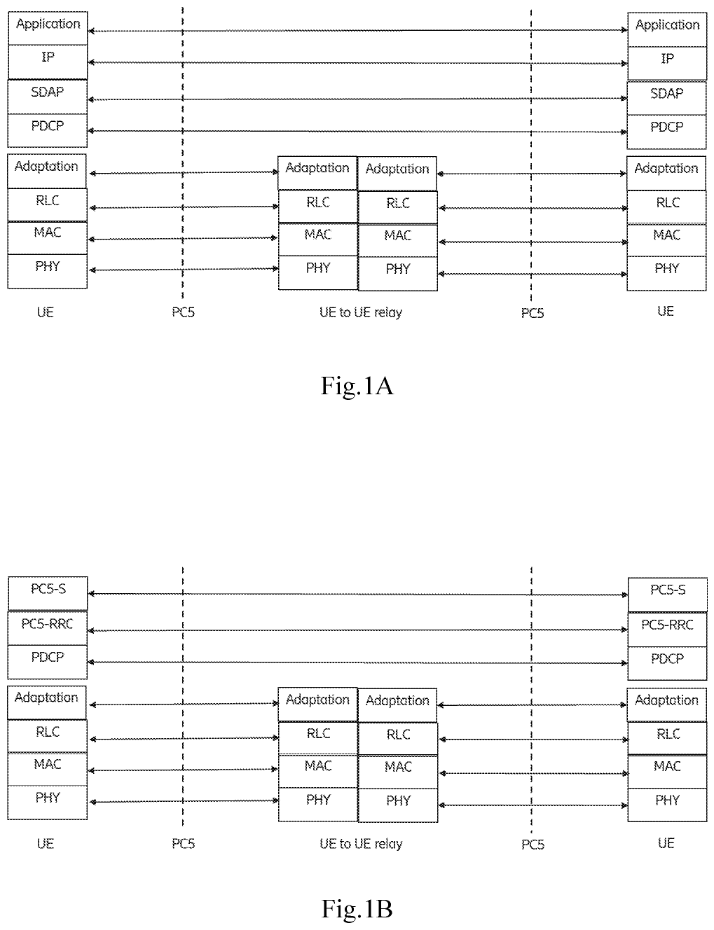

FIGS. 1A-1B are diagrams illustrating exemplary protocol stacks for a L2 UE-to-UE relay according to some embodiments of the present disclosure. The L2 UE-to-UE relay may provide the functionality to support connectivity between two UEs (also called source UE and target UE). The protocol stacks for L2 UE-to-UE relay are shown in FIG. 1A and FIG. 1B for user plane and control plane respectively. For simplicity, FIG. 1A and FIG. 1B only show some exemplary protocol layers such as physical (PHY) layer, medium access control (MAC) layer, radio link control (RLC) layer, adaptation layer, packet data convergence protocol (PDCP) layer, service data adaptation protocol (SDAP) layer, Internet protocol (IP) layer, application layer, radio resource control (RRC) layer on PC5 interface (PC5-RRC), etc.

It is noted that the two endpoints of the PC5 PDCP link are the source UE and the target UE, which means sidelink radio bearer (SLRB) and PC5-RRC are end to end. The relay function may be performed below the PDCP layer, e.g. the adaptation layer. The source UE's traffic (both control plane and user plane) may be transparently transferred between the source UE and the target UE over the L2 UE-to-UE relay without any modifications.

The adaptation layer between the source/target UE and the L2 UE-to-UE relay may be able to differentiate between SLRBs of a particular target/source UE. Different target/source UEs and different SLRBs of the target/source UE may be indicated by additional information (e.g. UE IDs and SLRB IDs) included in the adaptation layer header which is added to a PDCP protocol data unit (PDU). The adaptation layer may be considered as part of PDCP sublayer or a separate new layer between PDCP sublayer and RLC sublayer.

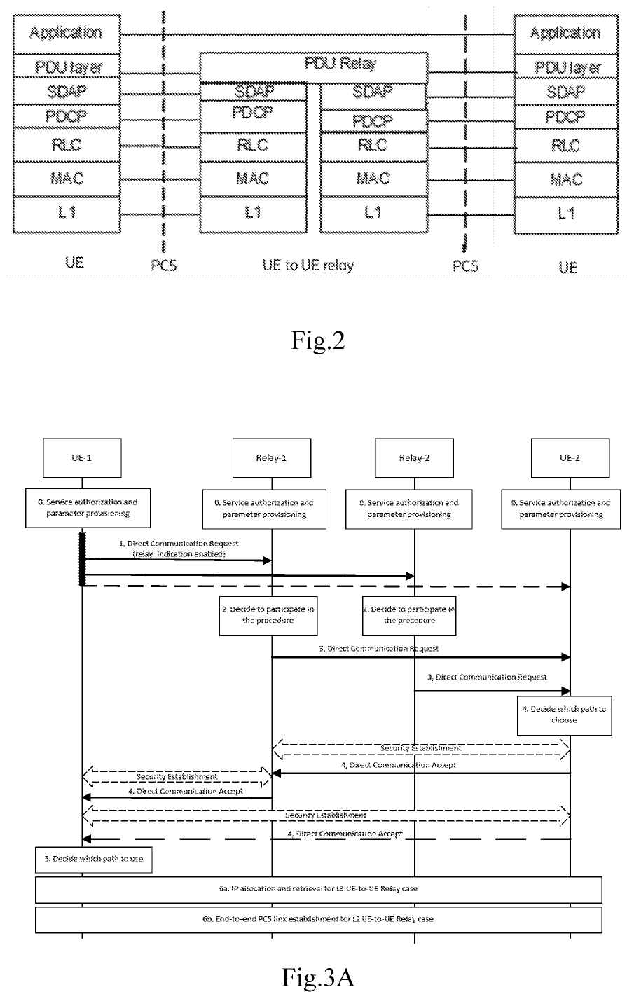

FIG. 2 is a diagram illustrating an exemplary protocol stack for a L3 UE-to-UE relay according to an embodiment of the present disclosure. The L3 UE-to-UE relay may relay unicast traffics between two UEs (also called source UE and target UE). It may provide generic function that can relay any IP, Ethernet or Unstructured traffic. According to the protocol stack for L3 UE-to-UE relay shown in FIG. 2, relaying may be performed in PDU layer. In an embodiment, the source UE may not be visible to the target UE and vice versa. The two endpoints of the PC5 PDCP link are the source/target UE and the relay UE, which means SLRB and PC5-RRC are per hop, i.e. there is no end to end SLRB, PC5-RRC and application service (AS) layer security.

In clause 6.8 of 3GPP technical report (TR) 23.752 V1.0.0 (where the entire content of this technical report is incorporated into the present disclosure by reference), an option on UE-to-UE relay discovery (i.e., solution #8 (sol #8)) is described as below:
When a source UE wants to communicate with a target UE, it will first try to find the target UE by either sending a Direct Communication Request or a Solicitation message with the target UE information. If the source UE cannot reach the target UE directly, it will try to discover a UE-to-UE relay to reach the target UE which may also trigger the relay to discover the target UE. To be more efficient, this solution tries to integrate target UE discovery and UE-to-UE relay discovery and selection together, including two alternatives:
   Alternative 1: UE-to-UE relay discovery and selection can be integrated into the unicast link establishment procedure, e.g., as described in clause 6.3.3 of 3GPP technical specification (TS) 23.287 V16.3.0 (where the entire content of this technical specification is incorporated into the present disclosure by reference).
   Alternative 2: UE-to-UE relay discovery and selection is integrated into Model B direct discovery procedure.
A new field is proposed to be added in the Direct Communication Request or the Solicitation message to indicate whether relays can be used in the communication. The field can be called relay_indication. When a UE wants to broadcast a Direct Communication Request or a Solicitation message, it indicates in the message whether a UE-to-UE relay may be used. For Release 17, it is assumed that the value of the indication is restricted to single hop.
When a UE-to-UE relay receives a Direct Communication Request or a Solicitation message with the relay_indication set, then it may decide whether to forward the message (i.e. modify the message and broadcast it in its proximity), according to e.g. Relay Service Code if there is any, Application ID, authorization policy (e.g. relay for specific ProSe Service), the current traffic load of the relay, the radio conditions between the source UE and the relay UE, etc.
There may exist a situation where multiple UE-to-UE relays can be used to reach the target UE or the target UE may also directly receive the Direct Communication Request or Solicitation message from the source UE. The target UE may choose which one to reply according to e.g. signal strength, local policy (e.g. traffic load of the UE-to-UE relays), Relay Service Code if there is any or operator policies (e.g. always prefer direct communication or only use some specific UE-to-UE relays).
The source UE may receive the responses which are from multiple UE-to-UE relays and may also be from the target UE directly, and the source UE may choose the communication path according to e.g. signal strength or operator policies (e.g. always prefer direct communication or only use some specific UE-to-UE relays).

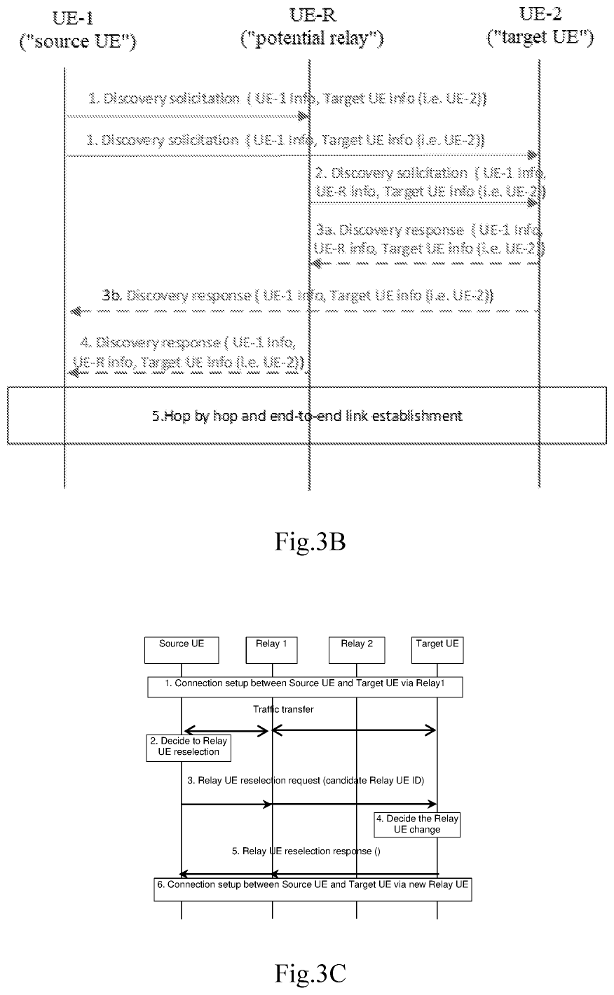

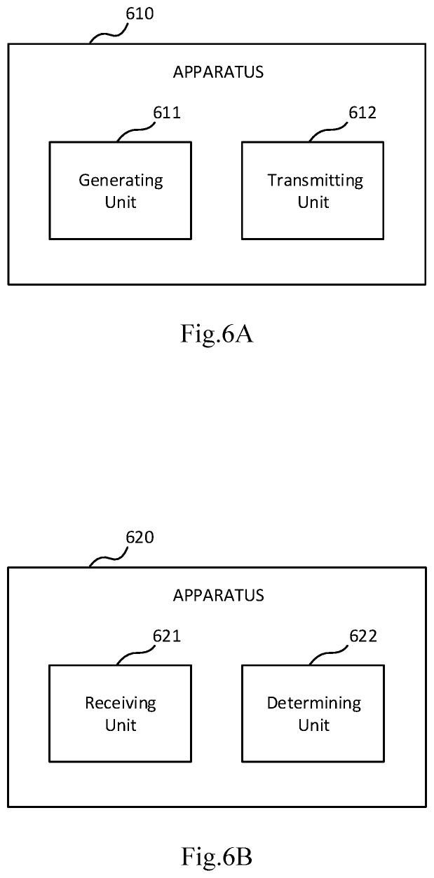

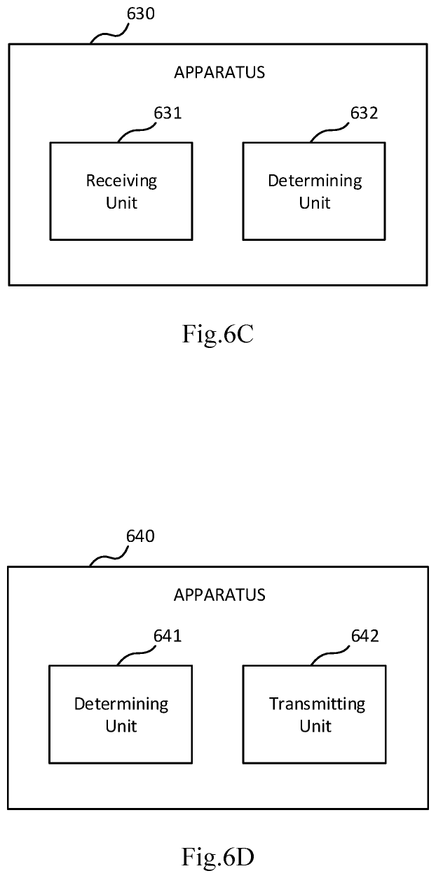

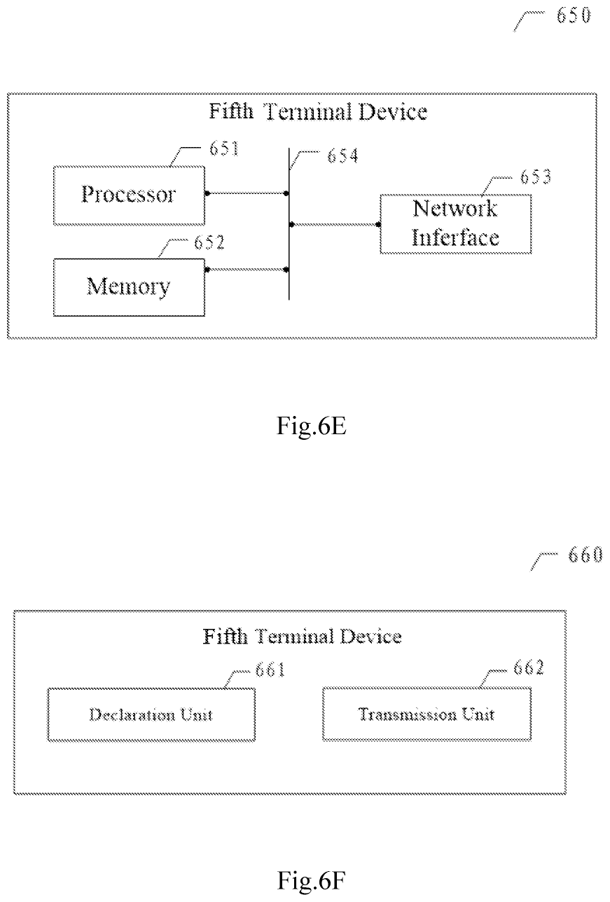

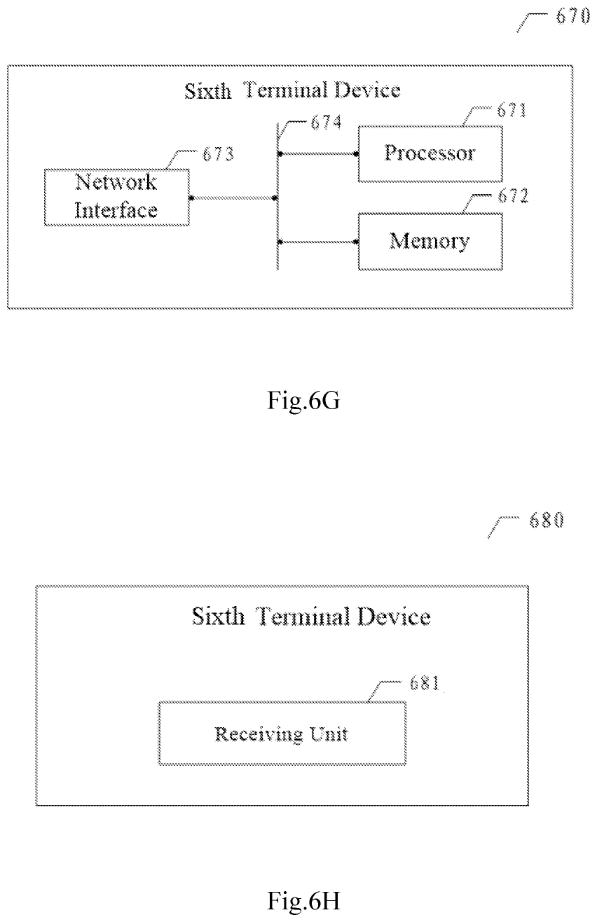

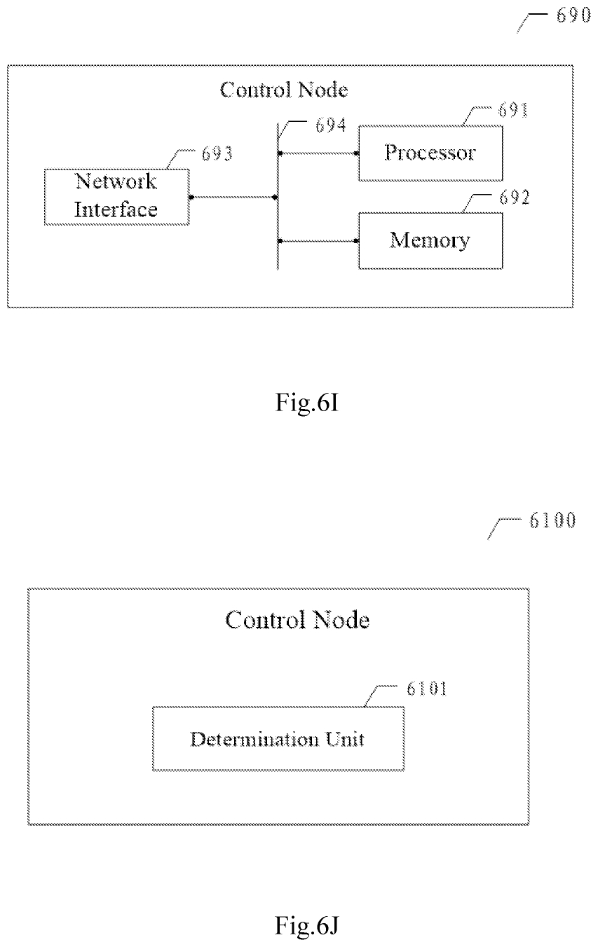

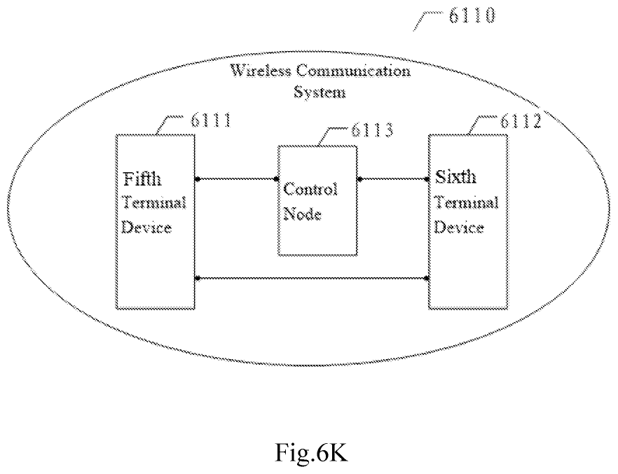

FIGS. 3A-3C are diagrams illustrating exemplary UE-to-UE relay selection according to some embodiments of the present disclosure. Alternative 1 where UE-to-UE relay discovery and selection is integrated into the unicast link establishment procedure is shown in FIG. 3A, which may correspond to FIG. 6.8.2.1-1 of 3GPP TR 23.752 V1.0.0. Alternative 2 where UE-to-UE relay discovery and selection is integrated into Model B direct discovery procedure is shown in FIG. 3B, which may correspond to FIG. 6.8.2.2-1 of 3GPP TR 23.752 V1.0.0. Another option on UE-to-UE relay reselection is shown in FIG. 3C, which may correspond to FIG. 6.50.2-1 of 3GPP TR 23.752 V1.0.0.

As described in 3GPP TR 23.752 V1.0.0, a procedure of 5G ProSe UE-to-UE relay selection shown in FIG. 3A may include the following steps:
0. UEs are authorized to use the service provided by UE-to-UE relays. The UE-to-UE relays are authorized to provide service of relaying traffics among UEs. The authorization and the parameter provisioning can use solutions for KI #8, e.g. Sol #36. The authorization can be done when UEs/relays are registered to the network. Security related parameters may be provisioned so that a UE and a relay can verify the authorization with each other if needed.
1. UE-1 wants to establish unicast communication with UE-2 and the communication can be either through a direct link with UE-2 or via a UE-to-UE relay. Then UE-1 broadcasts a Direct Communication Request with relay_indication enabled. The message may be received by Relay-1, Relay-2. The message may also be received by UE-2 if it is in the proximity of UE-1. UE-1 includes source UE information, target UE information, an application ID, as well as a relay service code if there is any. If UE-1 does not want relay to be involved in the communication, then it may make relay_indication disabled.
NOTE 1: The data type of relay_indication can be determined in Stage 3. Details of Direct Communication Request/Accept messages may be determined in Stage 3.
2. Relay-1 and Relay-2 decide to participate in the procedure. They broadcast a new Direct Communication Request message in their proximity without relay_indication enabled. If a relay receives this message, it may just drop it. When a relay broadcasts the Direct Communication Request message, it includes source UE information, target UE information and relay UE information (e.g. a relay UE ID) in the message and use the relay's L2 address as the source L2 ID. The relay may maintain association between the source UE information (e.g. the source UE L2 ID) and the new Direct Communication Request.
3. UE-2 receives the Direct Communication Requests from Relay-1 and Relay-2. UE-2 may also receive the Direct Communication Request message directly from the UE-1 if the UE-2 is in the communication range of UE-1.
4. UE-2 chooses Relay-1 and replies with a Direct Communication Accept message. If UE-2 directly receives the Direct Communication Request from UE-1, it may choose to setup a direct communication link by sending the Direct Communication Accept message directly to UE-1. After receiving the Direct Communication Accept message, a UE-to-UE relay retrieves the source UE information stored in step 2 and sends the Direct Communication Accept message to the source UE with its relay UE information added in the message.
After step 4, UE-1 and UE-2 have respectively setup the PC5 links with the chosen UE-to-UE relay.
NOTE 2: The security establishment between UE-1 and Relay-1, and between Relay-1 and UE-2 are performed before Relay-1 and UE-2 send Direct Communication Accept message. Details of the authentication/security establishment procedure are determined by SA3 work group (WG). The security establishment procedure can be skipped if there already exists a PC5 link between the source (or target) UE and the relay which can be used for relaying the traffic.
5. UE-1 receives the Direct Communication Accept message from Relay-1. UE-1 chooses a path according to e.g. policies (e.g. always choose a direct path if it is possible), signal strength, etc. If UE-1 receives the Direct Communication Accept/Response message requesting to accept directly from UE-2, it may choose to setup a direct PC5 L2 link with UE-2, e.g., as described in clause 6.3.3 of 3GPP TS 23.287 V16.3.0, then step 6 (including steps 6a and 6b) is skipped.
6a. For the L3 UE-to-UE Relay case, UE-1 and UE-2 finish setting up the communication link via the chosen UE-to-UE relay. The link setup information may vary depending on the type of relay, e.g. L2 or L3 relaying. Then UE-1 and UE-2 can communicate via the relay. Regarding IP address allocation for the source/remote UE, the addresses can be either assigned by the relay or by the UE itself (e.g. a link-local IP address), e.g., as defined in clause 6.3.3 of 3GPP TS 23.287 V16.3.0.
6b. For the L2 UE-to-UE Relay case, the source and target UEs can setup an end-to-end PC5 link via the relay, as described in Solution #9.
NOTE 3: In order to make a relay or path selection, the source UE can setup a timer after sending out the Direct Communication Request for collecting the corresponding response messages before making a decision. Similarly, the target UE can also setup a timer after receiving the first copy of the Direct Communication Request/message for collecting multiple copies of the message from different paths before making a decision.
NOTE 4: In the first time when a UE receives a message from a UE-to-UE relay, the UE may need to verify if the relay is authorized be a UE-to-UE relay. Similarly, the UE-to-UE relay may also need to verify if the UE is authorized to use the relay service. The verification details and how to secure the communication between two UEs through a UE-to-UE relay is to be defined by SA WG3.

Depicted in FIG. 3B is the procedure for UE-to-UE Relay discovery Model B, and the discovery/selection procedure is separated from hop by hop and end-to-end link establishment. As described in 3GPP TR 23.752 V1.0.0, a procedure of 5G ProSe UE-to-UE relay selection shown in FIG. 3B may include the following steps:
1. UE-1 broadcasts a discovery solicitation message carrying UE-1 information, target UE information (UE-2), an application ID, a relay service code if any, and UE-1 may also indicate relay_indication enabled.
2. On reception of discovery solicitation, the candidate relay UE-R broadcasts discovery solicitation carrying UE-1 information, UE-R information, target UE information. The relay UE-R uses the relay's L2 address as the source L2 ID.
3. The target UE-2 responds the discovery message. If the UE-2 receives a discovery solicitation message in step 1, then UE-2 responds a discovery response in step 3b with UE-1 information, UE-2 information. If not and UE-2 receives discovery solicitation in step 2, then UE-2 responds a discovery response message in step 3a with UE-1 information, UE-R information, UE-2 information.
4. On reception of the discovery response in step 3a, UE-R sends a discovery response with UE-1 information, UE-R information, UE-2 information. If more than one candidate relay UEs responding the discovery response message, UE-1 can select one relay UE based on e.g. implementation or link qualification.
5. The source and target UEs may need to setup PC5 links with the relay before communicating with each other. Alternatively, the source and target UEs can setup an end-to-end PC5 link via the relay if a L2 UE-to-UE relay is assumed.

In clause 6.50 of 3GPP TR 23.752 V1.0.0. another option on UE-to-UE relay reselection (i.e., Solution #50 (Sol #50)) is described as below:
This solution provides a solution for UE-to-UE relay reselection in Key Issue #4. Since the solution is independent of how the relay forwards traffics between a source UE and a target UE, this solution is applicable to both L2 UE-to-UE relays and L3 UE-to-UE relays.
Solution #8 provides a solution for UE-to-UE relay selection, and this solution is suitable for initial relay selection and it may be extended for UE-to-UE relay reselection. However, it will cause the UE-to-UE relay in proximity broadcast the relay discovery message. Under some cases, these broadcast messages can be avoided, by the source UE and the target UE negotiating the relay reselection using the existing relay connection.
After the connection between the source UE and the target UE is setup, the source UE and the target UE may receive relay discovery messages from the other UE-to-UE relays. The source UE or the target UE may find that the signal quality with other UE-to-UE relays is better than that with the currently used UE-to-UE relay. Alternatively or additionally, if the source UE or the target UE finds that the signal quality with the selected UE-to-UE relay is not good enough, it may initiate the discovery message to find the candidate UE-to-UE relays which can provide a better connection. After new candidate UE-to-UE relays have been identified, the source UE or the target UE may initiate the relay reselection procedure and then these two UEs can negotiate UE-to-UE relay reselection using the existing relay connection.

As described in 3GPP TR 23.752 V1.0.0, a procedure of UE-to-UE relay reselection shown in FIG. 3C may include the following steps:
1. Connection between Source UE and Target UE via Relay 1 is setup by using solutions such as Solution #9 and Solution #10, and Relay 1 is selected as a UE-to-UE relay, e.g. by using Solution #8.
2. The Source UE decides to perform UE-to-UE relay reselection. This may be triggered by receiving the relay discovery message from another UE-to-UE relay, and the signal quality with this UE-to-UE relay is better than that with Relay 1. Alternatively or additionally, the Source UE may initiate the discovery message to find candidate UE-to-UE relays which can provide a better connection, when it finds that the signal quality with Relay 1 is not good enough.
3. After the Source UE identifies the candidate UE-to-UE relays, the Source UE sends the UE-to-UE relay reselection request to the Target UE using the connection via Relay 1, and the request message includes the candidate UE-to-UE relay ID(s) ordered by the Source UE's preference based on e.g. the signal quality of UE-to-UE relays.
NOTE 1: Details of UE-to-UE relay reselection request message and how the message is forwarded by the UE-to-UE relay may depend on the L2 UE-to-UE relays and L3 UE-to-UE relays solution.
4. The Target UE decides to change from Relay 1 to a new UE-to-UE relay. The new UE-to-UE relay is chosen from the candidate UE-to-UE relay ID(s) included in the reselection request. This decision can be made based on a new UE-to-UE relay providing the best signal quality, additionally based on the order of candidate UE-to-UE relay ID (s) received from the Source UE. If the Target UE has not received a relay discovery message from a candidate UE-to-UE relay or does not connect to the candidate UE-to-UE relay, the Target UE may perform the UE-to-UE relay discovery procedure with a candidate UE-to-UE relay ID in the discovery message.
5. The Target UE sends a response to the Source UE via Relay 1 that includes the new UE-to-UE relay ID. If no new UE-to-UE Relay is chosen, the Target UE may not respond to the Source UE or send a response indicating relay reselection failure.
6. [Optional] If the Target UE choses a new UE-to-UE relay in step 5, the Source UE initiates the connection setup procedure via the new UE-to-UE relay, and also releases the connection via Relay 1.

In Solution #8 (Sol #8) of 3GPP TR 23.752 V1.0.0, it is the UE that receives the discovery or link establishment request message performs relay UE (re)selection, so the UE sending the message may assume that the peer UE will perform relay UE (re)selection. However, when the two UEs send the message at roughly the same time, both UEs may send the message to their peer before receiving the message from the peer. In this case, there may be a collision in relay (re)selection if both UEs perform relay (re)selection and different relay UEs are selected by the two UEs, or relay (re)selection may not be performed at all if both UEs assume that the peer UE will perform relay UE (re)selection. Similar problem may exist with Solution #50 (Sol #50) of 3GPP TR 23.752 V1.0.0, when e.g. both UEs decide to perform UE-to-UE relay reselection and send a relay reselection request to the peer UE at roughly the same time.

For UE-to-UE relay, various exemplary embodiments of the present disclosure propose a solution for relay UE (re)selection, e.g., for the case that multiple UEs trigger relay (re)selection for communication with each other. According to a scheme, a UE that generates or transmits a discovery or link establishment request message in a later time may perform relay UE (re)selection and send a response. Correspondingly, a UE that generates or transmits a discovery or link establishment request message in an earlier time may not perform relay UE (re)selection and send a response, or only does it after a timer is expired. In this scheme, a time stamp may be included in the discovery or link establishment request message. According to another scheme, a UE having a larger (or smaller) UE ID may perform relay UE (re)selection and send a response. Correspondingly, a UE having a smaller (or larger) UE ID may not perform relay UE (re)selection and send a response, or only does it after a timer is expired. Alternatively or additionally, similar schemes may be applied when two UEs have a unicast PC5 connection and coordinate relay reselection via the relay reselection request and response, i.e. to determine which UE may need to perform relay reselection and send the response.

Various exemplary embodiments of the present disclosure may be applied to avoid the collision due to that UEs communicating with each other perform relay (re)selection and send a response to the peer UE at the same or similar time, in which case it may be hard and complicated to determine which relay (re)selection results need to be followed.

It can be appreciated that although some exemplary embodiments are described in the context of NR, i.e., NR sidelink is used for direct communication between two UEs, various embodiments described in the present disclosure may be in general applicable to any kind of direct communication between UEs in a relay scenario, e.g., LTE sidelink, wireless fidelity (WiFi), etc.

It can be appreciated that various exemplary embodiments may be applicable to both L2 based relay scenario (e.g. as described with respect to FIG. 1A and FIG. 1B) and L3 based relay scenario (e.g. as described with respect to FIG. 2). Although some exemplary embodiments are described by referring Sol #8 and Sol #50 in 3GPP TR 23.752 V1.0.0 as examples, various embodiments described in the present disclosure are not limited by both solutions. Any relay (re)selection mechanism like Sol #8 or Sol #50 may also be applicable to various embodiments.

It can be realized that although some exemplary embodiments are described for UEs in the case of a relay path comprising two UE-to-UE hops, various embodiments described in the present disclosure may also be applicable for the case of a relay path comprising more than two UE-to-UE hops, i.e. more than one relay UE.

In accordance with an exemplary embodiment, when a UE sends a discovery or link establishment request message, a time stamp may be included in this message. The time stamp may represent the time that the message is generated or transmitted by the sending UE. Then this time stamp may be used by the receiving UE of the discovery or link establishment request message to decide whether or not to perform a relay (re)selection procedure.

In accordance with an exemplary embodiment, the UE that generates or transmits the discovery or link establishment request message in a later time may perform relay UE (re)selection. According to an embodiment, when receiving a discovery or link establishment request message from a peer UE, the UE may decode the message, in the case that this UE is the targeted UE of the received message, and it has not sent a discovery or link establishment request message where the targeted UE(s) include the peer UE, or it has sent such discovery or link establishment request message, but the time stamp in the received message indicates that the UE generates or transmits its own message later than the peer UE, then the UE may do relay (re)selection for communication with the peer UE and send a response to the peer UE which may include the relay (re)selection results. Otherwise, the UE may not do relay (re)selection for communication with the peer UE and not send a response to the peer UE.

In accordance with an exemplary embodiment, the UE that sends a discovery or link establishment request message earlier than the peer UE may do relay (re)selection and also start a waiting timer. If the UE does not receive a response from the peer UE before the timer is expired, it may send a response to the peer UE which may also include the relay (re)selection results. If the UE triggers the discovery or link establishment procedure towards more than one peer UE, the UE may start a timer that is common for all the peer UEs or independently configured for each of the peer UEs.

In accordance with an exemplary embodiment, when a relay UE receives a discovery or link establishment request message from a UE (denoted UE 1), the relay UE may decode the message. If the targeted UE(s) of the message include another UE (denoted UE 2) from which the relay UE has already received another discovery or link establishment request message and the targeted UE(s) of said another message include UE 1, then the relay UE may compare the time stamps included in the two discovery or link establishment request messages. If the message received from UE 1 is generated or transmitted later than that from UE 2, the relay UE may not further forward the message received from UE 1 to UE 2, but may forward the message received from UE 2 to UE 1. In this way, only UE 1 may receive the message from UE 2 and do relay (re)selection for communication with UE 2, while UE 2 may not receive the message from UE 1 and thus may not do relay (re)selection for communication with UE 1.

In accordance with an exemplary embodiment, in the case that the target user information in the received discovery or link establishment request message includes multiple targeted UEs, the relay UE may not further forward the message only if it has also received the respective discovery or link establishment request messages from all the targeted UEs and the time stamps in all the messages indicate that all the messages are generated or transmitted in an earlier time.

In accordance with an exemplary embodiment, the relay UE may always forward the received discovery or link establishment request message if the message does not include a time stamp and/or a target user information.

In accordance with an exemplary embodiment, it may be (pre)configured that the UE having a larger (or smaller) UE ID may perform relay UE (re)selection. The UE ID may be a L2 ID or an application user ID. According to an embodiment, it may be (pre)configured that the UE having a larger UE ID performs relay UE (re)selection. In this case, when receiving a discovery or link establishment request message from a peer UE, a UE may know the ID of the peer UE, further the UE may decode the message and check if it is the targeted UE. If it is the targeted UE and the UE has also sent a discovery or link establishment request message where the targeted UE(s) include the peer UE, and the ID of the UE is larger than that of the peer UE, the UE may do relay (re)selection for communication with the peer UE and send a response to the peer UE which may include the relay (re)selection results. Otherwise, the UE may not do relay (re)selection for communication with the peer UE and not send a response to the peer UE.

In accordance with an exemplary embodiment, the UE that has a smaller UE ID than the peer UE also does relay (re)selection according to a specific criterion when receiving a discovery or link establishment request message from the peer UE. According to an embodiment, the UE may start a waiting timer, and if it does not receive a response from the peer UE before the timer is expired, it may send a response to the peer UE which may include the relay (re)selection results.

It can be appreciated that a similar procedure may be implemented for the case where it is (pre)configured that the UE having a smaller UE ID performs relay UE (re)selection. In this case, the UE that has a larger UE ID than the peer UE may wait for a response from the peer UE, e.g., before a timer is expired. Optionally, the UE may also make relay (re)selection when receiving a discovery or link establishment request message from the peer UE, and send a response (which may include the relay (re)selection results) to the peer UE when the timer is expired.

In accordance with an exemplary embodiment, when a relay UE receives a discovery or link establishment request message from a UE (denoted UE 1), the relay UE may decode the message. If the targeted UE(s) of the message include another UE (denoted UE 2) from which the relay UE has already received another discovery or link establishment request message and the targeted UE(s) of said another message include UE 1, then the relay UE may compare the transmitting (Tx) or source UE ID for the two discovery or link establishment request messages (i.e. the IDs of UE 1 and UE 2). If UE 1's ID is larger than that of UE 2, the relay UE may not further forward the message received from UE 1 to UE 2, but may forward the message received from UE 2 to UE 1. In this way, only UE 1 may receive the message from UE 2 and do relay (re)selection for communication with UE 2, while UE 2 may not receive the message from UE 1 and thus may not do relay (re)selection for communication with UE 1.

In accordance with an exemplary embodiment, in the case that the target user information in the discovery or link establishment request message received from a UE (e.g., UE 1) includes multiple targeted UEs, the relay UE may not further forward the message only if it has also received the respective discovery or link establishment request messages from all the targeted UEs and UE 1's ID is larger than those of all the targeted UEs. Alternatively, the relay UE may not further forward the message received from UE 1 only if it has also received the respective discovery or link establishment request messages from all the targeted UEs and UE 1's ID is smaller than those of all the targeted UEs.

In accordance with an exemplary embodiment, when the two UEs have unicast communication with each other, they may coordinate which criterion (e.g., time stamp based or UE ID based criterion) may be used to determine which UE may need to perform a relay reselection (due to e.g. radio link failure (RLF), etc.) and inform the peer UE (first), and for the UE ID based criterion, whether UE with larger ID or smaller ID may need to perform relay reselection and inform the peer UE (first). According to an embodiment, the coordination may use one or more of the below signaling/message alternatives:
PC5-RRC signaling;
a MAC CE;
a control PDU of a protocol layer such as SDAP, PDCP, RLC or an adaptation layer; and
L1 signaling on channels including at least physical sidelink shared channel (PSSCH), physical sidelink common control channel (PSCCH), physical sidelink feedback channel (PSFCH).

In accordance with an exemplary embodiment, when the two UEs have unicast communication with each other, one UE may send a relay reselection request to the peer UE (e.g., by using sol #50 as described in 3GPP TR 23.752 V1.0.0). Similar solutions as above may be applied to solve the problems due to both UEs sending the relay reselection requests at roughly the same time. Exemplary embodiments may be implemented as below:
A time stamp representing the generation or transmission time of the relay reselection request message may be added in the message. When a UE receives a relay reselection request, it may determine by comparing the time stamps if it has generated or sent a relay reselection request message earlier or later than the peer UE. If it is earlier, the UE may not send a response to the peer UE, or only send the response after a (pre)configured timer is expired.
When a UE receives a relay reselection request from the peer UE, it may check if it has already sent a relay reselection request to the peer UE. If that is case, the UE may not send a response to the peer UE or only send the response after a (pre)configured timer is expired if its own UE ID (e.g. L2 ID, etc.) is smaller (or larger) than that of the peer UE. It may be (pre)configured whether the UE with larger (or smaller) ID may need to send the response (first).

In accordance with an exemplary embodiment, for a relay path containing multiple UE-to-UE (U2U) hops, in the case that any UE on the relay path has triggered a relay reselection event, the UE may distribute the event on the path, so that the other UEs are aware of this event, and therefore, the other UEs on the path may not trigger the same event while this event is being handled. According to an embodiment, a time period may be configured/preconfigured to the UE during which the UE is allowed to handle the event, i.e., find a target (relay) UE and perform a path switch to the target (relay) UE.

In accordance with an exemplary embodiment, for a relay selection/reselection trigger condition (such as PC5 link radio quality, e.g., reference signal received power (RSRP), etc.), each UE on a relay path may be configured/preconfigured with a different threshold. In this way, parallel triggering of relay selection/reselection at roughly the same time may be reduced to some extent.

It is noted that some embodiments of the present disclosure are mainly described in relation to 4G/LTE or 5G/NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

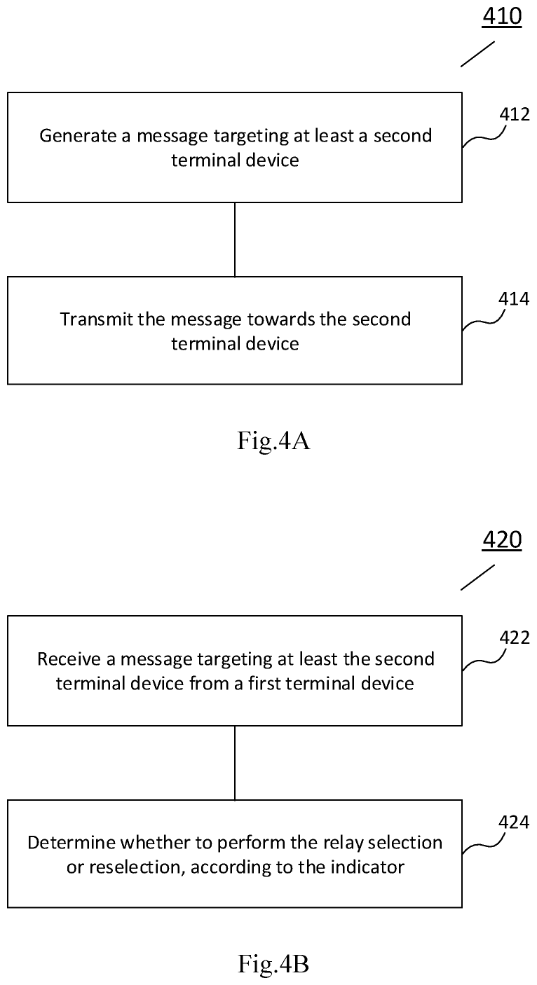

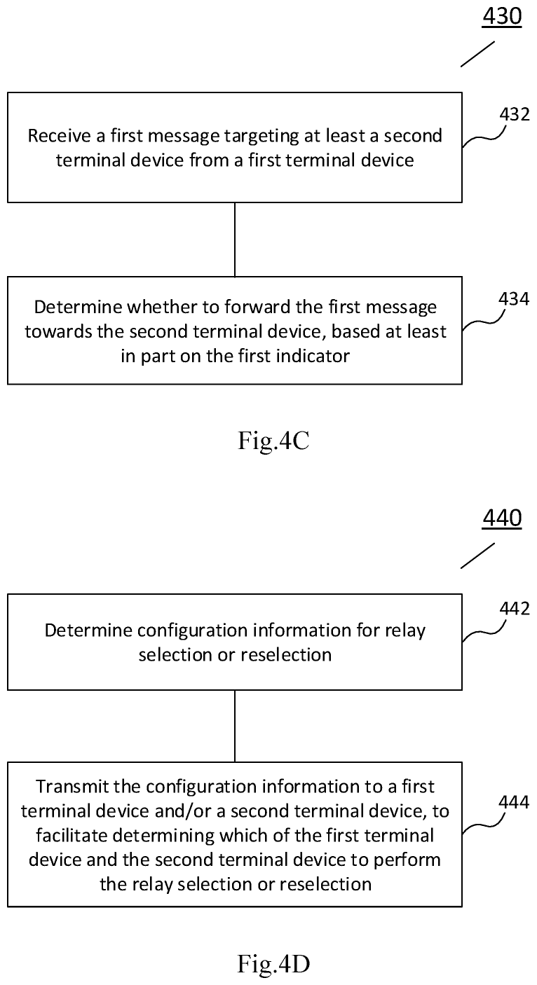

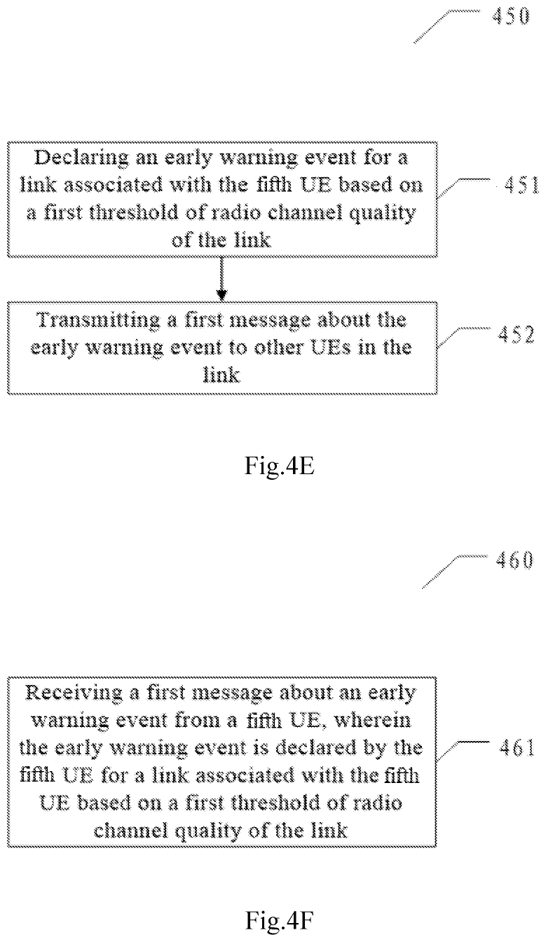

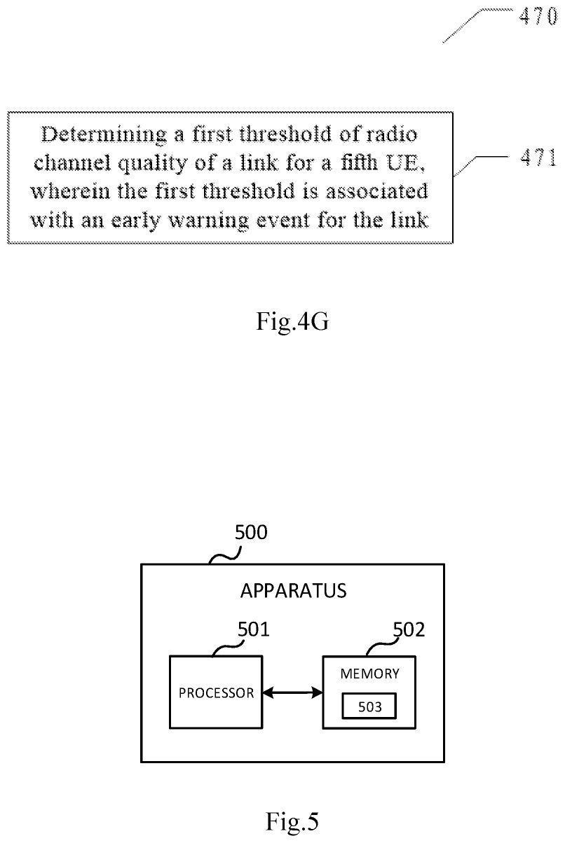

FIG. 4A is a flowchart illustrating a method 410 according to some embodiments of the present disclosure. The method 410 illustrated in FIG. 4A may be performed by a first terminal device or an apparatus communicatively coupled to the first terminal device. In accordance with an exemplary embodiment, the first terminal device may be configured to support D2D communication (e.g., V2X or SL communication, etc.) with other devices. In an exemplary embodiment, the first terminal device may be configured to communicate with a network node (e.g., an eNB, a gNB, etc.) directly or via a relay UE.

According to the exemplary method 410 illustrated in FIG. 4A, the first terminal device may generate a message targeting at least a second terminal device, as shown in block 412. The message may include an indicator used to determine which of the first terminal device and the second terminal device is to perform relay selection or reselection. In accordance with an exemplary embodiment, the first terminal device may transmit the message towards the second terminal device, as shown in block 414.

In accordance with an exemplary embodiment, the message may be a discovery or link establishment request message, a relay selection or reselection request message, or any other suitable messages which may be used to trigger a relay selection or reselection event. According to an embodiment, the message may be transmitted from the first terminal device to the second terminal device via at least a third terminal device capable of relaying.

In accordance with an exemplary embodiment, the indicator included in the message may be a time stamp representing a time when the first terminal device requests the relay selection or reselection. According to an embodiment, the time when the first terminal device requests the relay selection or reselection may be the time when the message is generated or transmitted by the first terminal device.

In accordance with an exemplary embodiment, when the time stamp indicates that the first terminal device requests the relay selection or reselection earlier than the second terminal device, it may be determined that the second terminal device is to perform the relay selection or reselection.

In accordance with an exemplary embodiment, the indicator included in the message may be an identifier of the first terminal device. According to an embodiment, when the identifier of the first terminal device is larger than an identifier of the second terminal device, it may be determined that the second terminal device is to perform the relay selection or reselection. According to another embodiment, when the identifier of the first terminal device is smaller than an identifier of the second terminal device, it may be determined that the second terminal device is to perform the relay selection or reselection.

In accordance with an exemplary embodiment, the first terminal device may receive a response to the message from the second terminal device. The response to the message may include a result of the relay selection or reselection performed by the second terminal device.

In accordance with an exemplary embodiment, the first terminal device may start a timer, in response to transmitting the message towards the second terminal device. According to an embodiment, the timer may be configurable for each peer device of the first terminal device. According to another embodiment, the timer may be common for all peer devices of the first terminal device.

In accordance with an exemplary embodiment, when the response to the message is not received by the first terminal device until the timer is expired, the first terminal device may perform the relay selection or reselection, and transmit a result of the relay selection or reselection performed by the first terminal device to the second terminal device.

In accordance with an exemplary embodiment, the first terminal device may perform a negotiation with the second terminal device to determine a criterion for determining which of the first terminal device and the second terminal device is to perform the relay selection or reselection. According to an embodiment, the criterion may be a time stamp based criterion, a device identifier based criterion or any other suitable criterion which may be used to determine which party will perform relay (re)selection and/or how to perform the relay (re)selection.

In accordance with an exemplary embodiment, the negotiation between the first terminal device and the second terminal device may be performed by PC5-RRC signaling, a MAC CE, a control PDU, and/or physical layer (L1) signaling, etc.

In accordance with an exemplary embodiment, the first terminal device may transmit a notification to one or more devices on a path between the first terminal device and the second terminal device. The one or more devices may include at least the second terminal device, and the notification may indicate that the first terminal device triggers a relay selection or reselection event.

In accordance with an exemplary embodiment, the first terminal device may handle the relay selection or reselection event during a time period. According to an embodiment, the one or more devices may not trigger the relay selection or reselection event during the time period.

In accordance with an exemplary embodiment, the relay selection or reselection event may be triggered by the first terminal device according to a threshold. In an embodiment, this threshold may be different from the respective thresholds configured for the one or more devices on the path between the first terminal device and the second terminal device to trigger the relay selection or reselection event.

In accordance with an exemplary embodiment, the first terminal device may receive configuration information for the relay selection or reselection from a base station and/or a fourth terminal device (e.g., a UE which may be able to control or manage the first terminal device, etc.). According to the configuration information, the first terminal device may determine how to perform the relay selection or reselection and/or set one or more related parameters of the relay selection or reselection.

FIG. 4B is a flowchart illustrating a method 420 according to some embodiments of the present disclosure. The method 420 illustrated in FIG. 4B may be performed by a second terminal device or an apparatus communicatively coupled to the second terminal device. In accordance with an exemplary embodiment, the second terminal device may be configured to support D2D communication (e.g., V2X or SL communication, etc.) with other devices. In an exemplary embodiment, the second terminal device may be configured to communicate with a network node (e.g., an eNB, a gNB, etc.) directly or via a relay UE.

According to the exemplary method 420 illustrated in FIG. 4B, the second terminal device may receive a message targeting at least the second terminal device from a first terminal device (e.g., the first terminal device as described with respect to FIG. 4A), as shown in block 422. The message may include an indicator used to determine which of the first terminal device and the second terminal device is to perform relay selection or reselection. In accordance with an exemplary embodiment, the second terminal device may determine whether to perform the relay selection or reselection, according to the indicator, as shown in block 424.

It can be appreciated that the steps, operations and related configurations of the method 420 illustrated in FIG. 4B may correspond to the steps, operations and related configurations of the method 410 illustrated in FIG. 4A. It also can be appreciated that the message received by the second terminal device according to the method 420 may correspond to the message transmitted by the first terminal device according to the method 410. Thus, the message as described with respect to FIG. 4A and the message as described with respect to FIG. 4B may have the same or similar contents and/or feature elements. Similarly, the indicator included in the message as described with respect to FIG. 4A and the indicator included in the message as described with respect to FIG. 4B may have the same or similar contents and/or feature elements

In accordance with an exemplary embodiment, the message (e.g., a discovery or link establishment request message, or a relay selection or reselection request message, etc.) may be received by the second terminal device from the first terminal device via at least a third terminal device capable of relaying.

In accordance with an exemplary embodiment, the indicator included in the message may be a time stamp representing a time when the first terminal device requests the relay selection or reselection (e.g., the time when the message is generated or transmitted by the first terminal device, etc.). When the time stamp indicates that the first terminal device requests the relay selection or reselection earlier than the second terminal device, the second terminal device may determine to perform the relay selection or reselection.

In accordance with an exemplary embodiment, the indicator included in the message may be an identifier of the first terminal device. When the identifier of the first terminal device is larger than an identifier of the second terminal device, the second terminal device may determine to perform the relay selection or reselection. In another embodiment, when the identifier of the first terminal device is smaller than an identifier of the second terminal device, the second terminal device may determine to perform the relay selection or reselection.

In accordance with an exemplary embodiment, the second terminal device may perform the relay selection or reselection and transmit a response to the message to the first terminal device. The response to the message may include a result of the relay selection or reselection performed by the second terminal device.

In accordance with an exemplary embodiment, when the response to the message is not received by the first terminal device until a timer is expired, the second terminal device may receive, from the first terminal device, a result of the relay selection or reselection performed by the first terminal device. According to an embodiment, the timer may be started by the first terminal device when the message is transmitted towards the second terminal device by the first terminal device.

In accordance with an exemplary embodiment, the second terminal device may perform a negotiation with the first terminal device (e.g., by PC5-RRC signaling, a MAC CE, a control PDU, and/or L1 signaling, etc.) to determine a criterion (e.g., a time stamp based or a device identifier based criterion, etc.) for determining which of the first terminal device and the second terminal device is to perform the relay selection or reselection.

In accordance with an exemplary embodiment, the second terminal device may receive a notification transmitted by the first terminal device to one or more devices on a path between the first terminal device and the second terminal device. The one or more devices may include at least the second terminal device, and the notification may indicate that the first terminal device triggers a relay selection or reselection event.

In accordance with an exemplary embodiment, the second terminal device may receive configuration information for the relay selection or reselection from a base station and/or a fourth terminal device (e.g., a UE which may be able to control or manage the second terminal device, etc.). According to the configuration information, the second terminal device may determine how to perform the relay selection or reselection and/or set one or more related parameters of the relay selection or reselection.

FIG. 4C is a flowchart illustrating a method 430 according to some embodiments of the present disclosure. The method 430 illustrated in FIG. 4C may be performed by a third terminal device or an apparatus communicatively coupled to the third terminal device. In accordance with an exemplary embodiment, the third terminal device may be configured to support D2D communication (e.g., V2X or SL communication, etc.) with other devices. In accordance with another exemplary embodiment, the third terminal device may be able to support a L2 relaying capability and/or a L3 relaying capability. In an exemplary embodiment, the third terminal device may be configured to communicate with a network node (e.g., an eNB, a gNB, etc.) directly or via a relay UE.

According to the exemplary method 430 illustrated in FIG. 4C, the third terminal device may receive a first message targeting at least a second terminal device (e.g., the second terminal device as described with respect to FIG. 4B) from a first terminal device (e.g., the first terminal device as described with respect to FIG. 4A), as shown in block 432. The first message may include a first indicator used to determine which of the first terminal device and the second terminal device is to perform relay selection or reselection. In accordance with an exemplary embodiment, the third terminal device may determine whether to forward the first message towards the second terminal device, based at least in part on the first indicator, as shown in block 434.

It can be appreciated that the first message received by the third terminal device according to the method 430 may correspond to the message transmitted by the first terminal device according to the method 410. Thus, the message as described with respect to FIG. 4A and the first message as described with respect to FIG. 4C may have the same or similar contents and/or feature elements.

In accordance with an exemplary embodiment, the first indicator may be a first time stamp representing the time when the first terminal device requests the relay selection or reselection. According to an embodiment, the first time stamp may indicate the time when the first message is generated or transmitted by the first terminal device.

In accordance with an exemplary embodiment, the third terminal device may receive a second message targeting at least the first terminal device from the second terminal device. The second message may include a second indicator such as a second time stamp representing the time when the second terminal device requests the relay selection or reselection. According to an embodiment, the second time stamp may indicate the time when the second message is generated or transmitted by the second terminal device.

In accordance with an exemplary embodiment, the third terminal device may compare the first time stamp and the second time stamp to determine whether the first terminal device requests the relay selection or reselection earlier than the second terminal device. According to an embodiment, when the first terminal device requests the relay selection or reselection earlier than the second terminal device, the third terminal device may determine to forward the first message towards the second terminal device. According to another embodiment, when the first terminal device requests the relay selection or reselection later than the second terminal device, the third terminal device may determine not to forward the first message towards the second terminal device.

In accordance with an exemplary embodiment, the first indicator may be an identifier of the first terminal device. According to an embodiment, the third terminal device may receive a second message targeting at least the first terminal device from the second terminal device. The second message may include a second indicator such as an identifier of the second terminal device. The third terminal device may compare the identifiers of the first terminal device and the second terminal devices.

In accordance with an exemplary embodiment, when the identifier of the first terminal device is larger than the identifier of the second terminal device, the third terminal device may determine to forward the first message towards the second terminal device. When the identifier of the first terminal device is smaller than the identifier of the second terminal device, the third terminal device may determine not to forward the first message towards the second terminal device.

In accordance with another exemplary embodiment, when the identifier of the first terminal device is smaller than the identifier of the second terminal device, the third terminal device may determine to forward the first message towards the second terminal device. When the identifier of the first terminal device is larger than the identifier of the second terminal device, the third terminal device may determine not to forward the first message towards the second terminal device.

In accordance with an exemplary embodiment, the third terminal device may forward the first message towards the second terminal device, e.g., without forwarding the second message towards the first terminal device. According to an embodiment, the third terminal device may receive a response to the first message from the second terminal device, and forward the response to the first message to the first terminal device. The response to the first message may include a result of the relay selection or reselection performed by the second terminal device.

In accordance with an exemplary embodiment, the third terminal device may forward the second message towards the first terminal device, e.g., without forwarding the first message towards the second terminal device. According to an embodiment, the third terminal device may receive a response to the second message from the first terminal device, and forward the response to the second message to the second terminal device. The response to the second message may include a result of the relay selection or reselection performed by the first terminal device.

In accordance with an exemplary embodiment, the first message may target two or more terminal devices including the second terminal device. According to an embodiment, when the first terminal device requests the relay selection or reselection later than the two or more terminal devices, the third terminal device may determine not to forward the first message towards the two or more terminal devices. According to another embodiment, when an identifier of the first terminal device is smaller than identifiers of the two or more terminal devices, the third terminal device may determine not to forward the first message towards the two or more terminal devices. According to a further embodiment, when an identifier of the first terminal device is larger than identifiers of the two or more terminal devices, the third terminal device may determine not to forward the first message towards the two or more terminal devices.

In accordance with an exemplary embodiment, the third terminal device may always forward a message including no time stamp and/or target user information.

In accordance with an exemplary embodiment, the third terminal device may receive a notification transmitted by the first terminal device to one or more devices on a path between the first terminal device and the second terminal device. The one or more devices may include at least the second terminal device and the third terminal device, and the notification may indicate that the first terminal device triggers a relay selection or reselection event. In an embodiment, during a time period of handling the relay selection or reselection event by the first terminal device, the one or more devices on the path between the first terminal device and the second terminal device may not trigger the relay selection or reselection event.

In accordance with an exemplary embodiment, the third terminal device may receive configuration information for the relay selection or reselection from a base station and/or a fourth terminal device (e.g., a UE which may be able to control or manage the third terminal device, etc.). According to the configuration information, the third terminal device may determine how to perform (or facilitate performing) the relay selection or reselection and/or set one or more related parameters of the relay selection or reselection.

In accordance with an exemplary embodiment, the first message received by the third terminal device from the first terminal device may be a discovery or link establishment request message, or a relay selection or reselection request message. Similarly, the second message received by the third terminal device from the second terminal device may be a discovery or link establishment request message, or a relay selection or reselection request message.

FIG. 4D is a flowchart illustrating a method 440 according to some embodiments of the present disclosure. The method 440 illustrated in FIG. 4D may be performed by a communication device (e.g., a network node, a terminal device, etc.) or an apparatus communicatively coupled to the communication device. In accordance with an exemplary embodiment, the communication device may be configured to support cellular coverage extension with D2D communication (e.g., V2X or SL communication, etc.). In an exemplary embodiment, the communication device may be configured to communicate with a terminal device such as a UE, e.g. directly or via a relay. In accordance with another exemplary embodiment, the communication device may be able to support a L2 relaying capability and/or a L3 relaying capability.

According to the exemplary method 440 illustrated in FIG. 4D, the communication device may determine configuration information for relay selection or reselection, as shown in block 442. In accordance with an exemplary embodiment, the communication device may transmit the configuration information to a first terminal device and/or a second terminal device, to facilitate determining which of the first terminal device and the second terminal device to perform the relay selection or reselection, as shown in block 444.

In accordance with an exemplary embodiment, the configuration information may indicate a criterion (e.g., a time stamp based criterion or a device identifier based criterion, etc.) for determining which of the first terminal device and the second terminal device is to perform the relay selection or reselection.

In accordance with an exemplary embodiment, the configuration information may indicate one or more of:
a timer configuration based on waiting time for a response to a relay selection or reselection request;
a forwarding configuration for one or more relay selection or reselection requests; and
a trigger configuration for a relay selection or reselection event.

In accordance with an exemplary embodiment, the communication device may transmit the configuration information to a third terminal device and/or any other suitable devices which may be involved in the configuration of relay (re)selection. The first terminal device may communicate with the second terminal device via the third terminal device.

In accordance with an exemplary embodiment, the communication device may be a base station or a fourth terminal device (e.g., a UE capable of controlling and/or managing at least one of the first terminal device, the second terminal device and the third terminal device, etc.).

It can be appreciated that the first terminal device as described with respect to FIG. 4A may also be configured to perform the method 420 as described with respect to FIG. 4B, the method 430 as described with respect to FIG. 4C, or the method 440 as described with respect to FIG. 4D, for example, according to different service requirements and/or capabilities of the first terminal device. Similarly, the second terminal device as described with respect to FIG. 4B may also be configured to perform the method 410 as described with respect to FIG. 4A, the method 430 as described with respect to FIG. 4C, or the method 440 as described with respect to FIG. 4D. The third terminal device as described with respect to FIG. 4C may also be configured to perform the method 410 as described with respect to FIG. 4A, the method 420 as described with respect to FIG. 4B, or the method 440 as described with respect to FIG. 4D.

The various blocks shown in FIGS. 4A-4D may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

SA2 has made the below conclusions regarding UE-to-UE relay selection/reselection:
For Relay reselection, the negotiated UE-to-UE Relay reselection in Sol #50 and the Relay selection in Sol #8 can be used under different conditions. Both Sol #50 and Sol #8 can be taken as baseline.

It should be noted that it is left to RAN2 (radio access network 2) to decide the radio criteria on Relay reselection.

According to the conclusions, both Sol #50 and Sol #8 are taken as baseline.

By nature, Sol #8 is a transmitter UE (TX-UE) centric solution. In other words, it is TX UE that triggers relay selection/reselection and makes the final decision on selection of the target relay UE. On the contrary, Sol #50 is a receiver UE (RX-UE) centric solution. With this solution, a TX UE can trigger relay reselection. The final decision on selection of the target relay UE is left to RX UE. To some extent, TX UE and RX UE can negotiate with each other on selection of target relay UE. Meanwhile, Sol #50 may be only applicable in case the link is not broken; otherwise, TX UE and RX UE will not be able to negotiate with each other. In addition, it is risky that TX UE and RX UE may not be able to achieve agreement. In that case, the relay reselection procedure will be terminated and cause service disruption.

In the context of NR sidelink, two solutions, such as Sol #8 and Sol #50, are applicable under different conditions. However, what conditions are unclear; therefore, it needs further study in normative phase. The study needs to consider pros and cons of both Sol #8 and Sol #50.

The embodiments of the present disclosure are described in the context of NR, i.e., remote UEs and relay UEs are deployed in the same NR cell or different NR cells. The embodiments are also applicable to other relay scenarios where the links between the remote UEs and the relay UEs may be based on LTE sidelink or NR sidelink.

The embodiments are applicable to both L2 and L3 based relay scenarios.

In the below embodiments, both Sol #8 and Sol #50 of TR 23.752 v 0.7.0 are referred to as examples. However, the below embodiments are not limited to both of the solutions. Any relay (re)selection mechanism like Sol #8 or Sol #50 is also applicable. A solution is like Sol #8, meaning that TX/source UE triggers a relay (re)selection procedure and decides which target relay UE should be selected. In the procedure, the U2U Relay discovery procedure may be performed. A solution is like Sol #50, meaning that TX/source UE can trigger relay (re)selection procedure. The TX/source UE sends a request message containing candidate target relay UE IDs to RX/target UE. RX/target UE decides the target relay UE considering the candidate target relay UE IDs in the request message. In addition, a Sol #50 like option may also allow a target UE to trigger relay (re)selection. Eventually, TX/source UE may make final decision based on negotiation with target UE.

In the below embodiments, the terms “source UE”, “TX UE” and “source remote UE” are used to refer to a UE which initiates a relay path setup via a relay UE towards another UE. Meanwhile, the terms “target UE”, “RX UE”, “destination UE”, “target remote UE” and “destination remote UE” are used to refer to a UE on a relay path operating as a receiving UE. In addition, there is no strict definition on “TX UE” or “RX UE”. A TX UE may change role to be a RX UE, and vice versa, a RX UE may change role to be a TX UE. On a U2U relay path, one or multiple intermediate UEs may be interconnected to form the path. All these intermediate UEs are referred to as “relay UEs”.

In the below embodiments, the term “relay path” and “end to end (E2E) connection” are used to stand for an end to end connection containing multiple PC5 links/hops.

In addition, the below embodiments are applicable to source UE, target UE or relay UE on a relay path.

In a first embodiment, at least one threshold of radio channel quality in terms of metrics, such as RSRP, RSRQ, RSSI, SINR, SIR, channel busy ratio etc., is configured/preconfigured to a UE (i.e., source UE, relay UE, or target UE) for indicating early warning that the UE's PC5 unicast link may soon become bad. In the case that the threshold is fulfilled (e.g., measured radio quality is less than the threshold for a configured time period), the UE determines that the link may soon become bad. However, the current link/connection may still have acceptable quality to transmit and receive packets.

In case the UE has multiple PC5 unicast links, the UE may be configure/preconfigured with a separate threshold per link.

In a second embodiment, in the case that the UE connects to an E2E connection, the UE declares an early warning event on a hop of the E2E connection, the UE applies at least one of the below actions:
distributing a message to the neighbor or the rest UEs on the path via at least one of the below signaling alternatives:
   PC5-RRC (radio resource control) signaling,
   MAC (media access control) CE (control element),
   Control PDU (protocol data unit) of a protocol layer such as SDAP (service data adaptation protocol), PDCP (packet data convergence protocol), RLC (radio link control) or an adaptation layer, and
   L1 (Layer-1) signaling on channels including at least PSSCH (physical sidelink shared channel), PSCCH (physical sidelink common control channel), PSFCH (physical sidelink feedback channel).

The message contains at least information such as warning cause, hops/UEs that are concerned on the path due to the detected early warning event, the time when the warning event has been detected, etc.

In the case that a UE declares an early warning event or receives a message informing the early warning, the UE may perform the following:
Triggering relay UE (re)selection to replace the UEs/hops that are concerned due to the warning event.
Suspending traffic transmission, optionally only for specific services of which the QoS requirement will not be able to be fulfilled when the early warning event is triggered.
Informing the early warning to upper layer.
Informing the early warning to the gNB in a new RRC message or an existing RRC message (e.g. SidelinkUEInformation), if the UE is in RRC_CONEECTED. Alternatively, if the UE in RRC_INACTIVE the UE may perform the RRC resume procedure in order to inform the gNB.

In a third embodiment, upon trigger of relay (re)selection, the concerned UE that has detected an early warning event would send a request message to other UEs (e.g., source, target or relay UEs) on the path. The request message contains at least one discovered candidate relay UEs which can replace the concerned UEs (i.e., relay UEs) so that the E2E connection can be restored from the warning event in an early state before the E2E connection is really broken. In order to discover candidate relay UEs, the UE may perform the U2U discovery procedure in proximity. After sending the request message, the UE starts a timer with a time period which allows the receiving UE to decide/select target relay UEs. After the receiving UE receives the request message, the receiving UE may discover candidate relay UEs by itself. In addition, the receiving UE may also consider the candidate relay UEs included in the request message. The receiving UE may therefore provide response message to the UE that has sent the request message. When the concerned UE receives the response message by the receiving UE, the timer started by the concerned UE is stopped.

Alternatively or additionally, in the case that the timer is still running when the UE that has sent the request message receives a response message indicating that a target relay UE is selected, the UE can setup a new connection between the UE and the selected relay UE, to replace the old connection/relay segment and only when the new connection is correctly setup the timer is stopped.

In the case that the timer is still running, the UE that has sent the request message receives a response message indicating that there is no candidate relay UE selected, the UE declares a failure (e.g., RLF) for the E2E connection/link.

In the case that the timer is expired, while the UE has not received any response, the UE declares a failure (e.g., RLF) for the E2E connection/link. The timer is stopped.

The above mentioned option is an updated option on top of Sol #50, with improvements such as:
A timer is introduced to set a maximum period to allow the receiving UE to conclude a target relay UE. In this way, it is avoided that the UE waits too long time especially in case the receiving UE may not be able to find any candidate relay UE.
Conditions under which the UE can declare early warning and RLF for the E2E connection are defined.
The relay reselection solution, such as Sol #50, may be triggered by either the source UE or the target UE.

In a fourth embodiment, after the E2E connection is restored from the early warning (e.g., RLF is not declared), the UE may spread a message to (neighbor) UEs on the path indicating that the E2E connection has been restored. The message is sent by the UE via at least one of the below signaling alternatives:
PC5-RRC signaling,
MAC CE,
Control PDU of a protocol layer such as SDAP, PDCP, RLC or an adaptation layer, and
L1 signaling on channels including at least PSSCH, PSCCH, PSFCH.

The message contains at least one of the information such as warning cause, hops/UEs that are concerned on the path due to the detected early warning event, the time when the warning event has been detected, the time when the warning event has been restored, etc.

In the case that a UE restores the connection or receives a message informing the connection restoring, the UE may perform the following:
Resuming transmission of traffic that has been suspended.
Informing the restoring to upper layer.
Informing the restoring to the gNB in a new RRC message or an existing RRC message (e.g. SidelinkUEInformation), if the UE is in RRC_CONEECTED.

In a fifth embodiment, an E2E connection contains multiple hops. RLF is declared on any hop when one of the below events/conditions occurs:
a maximum number of out of sync instances on the link has been reached.

The UE may monitor the PC5 radio channel quality based on a specific reference symbol. The UE compares the measured channel quality with the out-of-sync and in-sync thresholds, Qout and Qin respectively. The physical channel evaluates the PC5 channel quality, and periodically sends indication on out-of-sync or in-sync to layer 3. The UE layer 3 then evaluates if the radio link failure based on the in-sync and out-of-sync indications are output from the layer 3 filter. For RLM (radio link monitoring) on the PC5 link, a counter and/or a timer may be defined. In an example, when the consecutively received out-of-sync indications are beyond a configured counter, a timer is started. While the timer is running, the radio link considered to be recovered if the UE consecutively receives a configured number of in-sync indications from the physical layer.
a maximum number of RLC retransmissions has been reached;
a configuration or reconfiguration error occurs upon reception of an RRC configuration/reconfiguration signaling message; and
a maximum number of HARQ (hybrid automatic repeat request) DTXs (discontinuous transmissions) has been reached.

The UE would further declare RLF for the E2E connection in case RLF is declared on any hop of the E2E connection.

In a sixth embodiment, the source UE or the target UE on the E2E connection declares RLF for the E2E connection when one of the below events/conditions occurs on the E2E connection:
a maximum number of RLC retransmissions has been reached, and
a configuration or reconfiguration error occurs upon reception of an RRC configuration/reconfiguration signaling message.

In a seventh embodiment, upon declaration of RLF for the E2E connection/link, the UE (e.g., UE1) performs the U2U discovery procedure in proximity. The UE sends a discovery message to neighbor UEs containing the information such as UE1 ID and target UE ID (e.g., UE2). There may be multiple neighbor UEs (e.g., UE-R) which provide response messages containing information such as UE1 ID, UE-R ID, and UE2 ID. UE1 therefore selects a neighbor UE as the relay UE. After that, the E2E connection between UE1 and UE2 can be established.

The discovery and/or the link establishment message may also include cause info, e.g. the discovery/link establishment is caused by RLF/early warning and/or the discovery/link establishment is for recovering an ongoing communication, the candidate relay UE may prioritize a link establishment request for a recovery purpose over other requests.

The above mentioned procedure is one option covered in Sol #8, i.e., Sol #8 like, with improvements such as:
The option is applied under specific conditions such as RLF.
The relay reselection solution, such as Sol #8, may be triggered by either the source UE or the target UE.

As a further alternative, if the concerned UE has the possibility to establish a Uu direct connection with a gNB, the concerned UE, if in RRC_INACTIVE, may perform the RRC resume procedure and continue transmission over the gNB. If the concerned UE is, instead, in RRC_IDLE, then the concerned UE may start the RRC setup procedure.

In sn eighth embodiment, at least one threshold of radio channel quality in terms of metrics, such as RSRP, RSRQ, RSSI, SINR, SIR, channel busy ratio etc., is configured/preconfigured to a UE (i.e., source UE, relay UE, or target UE) for indicating that the UE's PC5 unicast link has been too bad. In case the threshold is fulfilled (e.g., measured radio quality is less than the threshold for a configured time period), the UE determines that the link has been too bad. The UE may declare RLF for the link.

Compared to the early warning threshold, this threshold is set a lower value.

In the case that the UE has multiple PC5 unicast links, the UE may be configure/preconfigured with a separate threshold per link.

Alternatively or additionally, the UE does not declare RLF for the link. The UE just initiates the U2U discovery procedure in proximity as described in the seventh embodiment.

In a ninth embodiment, one set of UE-to-UE relay reselection criteria is provisioned to the source/target UE during the UE registration phase as described in TS 23.502. The criteria can be contained in the UE policy container from a policy control function (PCF) to the UE. The criteria may also be provisioned by the ProSe Application Server. For different services or applications, the criteria may be different.

The criteria may include the following parameters:
UE-to-UE relay load threshold, when the number of the UEs served by the relay is higher than the threshold, then the UE-to-UE relay reselection should be triggered.
Signal strength threshold,
Packet lost rate or retransmission rate,
Packet latency, and
Maximum data burst volume.

In a tenth embodiment, when the source/target UEs are in NR coverage, they report, to the gNB, which UE-to-UE relay they are connected to, as well as which relays they can reach (e.g. by receiving a relay announcement message). The gNB may decide if the UE-to-UE reselection should be triggered.

For any of the above embodiments, any relevant signaling or configuration may be signaled by a gNB or a controlling UE.

FIG. 4E is a flow chart illustrating a method 450 implemented on a fifth terminal device according to some embodiments of the present disclosure. As an example, operations of this flow chart may be performed by a fifth UE which has detected early warning of the link, but they are not limited thereto. The operations in this and other flow charts will be described with reference to the exemplary embodiments of the other figures. However, it should be appreciated that the operations of the flow charts may be performed by embodiments of the present disclosure other than those discussed with reference to the other figures, and the embodiments of the present disclosure discussed with reference to these other figures may perform operations different than those discussed with reference to the flow charts.

In one embodiment, the fifth UE may declare an early warning event for a link associated with the fifth UE based on a first threshold of radio channel quality of the link (block 451). By way of example, the first threshold may be preconfigured or configured by a control node for the fifth UE. As an example, when the fifth UE is associated with more than one link, the first threshold may be configured per link. The fifth UE may transmit a first message about the early warning event to other UEs in the link (block 452).

As an example, the first message may be transmitted via at least one of: PC5-RRC signaling; MAC CE; a control PDU of a protocol layer; and L1 signaling.

As an example, the first message may contain at least one of: a warning cause; information indicating at least one hop associated with the early warning event and/or the fifth UE; and a time when the early warning event is detected.

As an example, upon the declaration of the early warning event, the method may further comprise at least one of: suspending part of traffic transmission; informing an upper layer of the early warning event; and informing a control node of the early warning event.

As an example, when the fifth UE is in RRC_CONNECTED, the early warning event may be informed to the control node in an RRC message, and when the fifth UE is in RRC_INACTIVE, the early warning event may be informed to the control node by an RRC resume process.

As an example, when the fifth UE is one of two remote UEs associated with the link, a first relay reselection may be triggered. As a further example, the first relay reselection may be Sol #50.

As a further example, a first timer may be started by the fifth UE upon transmission of the first message to set a time period for the other of the two remote UEs to discover and/or select at least one candidate relay UE. As a still further example, the first timer may be stopped in response to the fifth UE receiving a response from the other remote UE. As another further example, the first timer may be stopped in response to establishment of a connection between the fifth UE and a selected relay UE indicated by a response received from the other remote UE. As yet another further example, an RLF may be declared in response to reception of a response from the other remote UE indicating that no relay UE is selected.

As a further example, an RLF may be declared by the fifth UE in the case that for the link: a maximum number of RLC retransmissions is reached; or a configuration or reconfiguration error occurs upon reception of an RRC configuration or reconfiguration signaling message.

As an example, an RLF may be declared in the case that for a hop of the link: a maximum number of out-of-sync instances on the link is reached; a maximum number of RLC retransmissions is reached; a configuration or reconfiguration error occurs upon reception of an RRC configuration or reconfiguration signaling message; or a maximum number of hybrid automatic repeat request discontinuous transmissions is reached.

As a further example, in the case that the maximum number of out-of-sync instances on the link is reached, when consecutively received out-of-sync indications are beyond a predetermined counter, a second timer may be started. As a still further example, when the fifth UE consecutively receives a predetermined number of in-sync indications from a physical layer during running of the second timer, the link may be considered to be restored.

As an example, after the link is restored from the early warning event, a second message about the restoration may be transmitted to other UEs in the link via at least one of: PC5-RRC signaling; MAC CE; a control PDU of a protocol layer; and L1 signaling.

As a further example, the second message may contain at least one of: a warning cause; information indicating at least one hop associated with the early warning event and/or at least the fifth UE; a time when the early warning event is detected; and a time when the link is restored.

As a further example, upon the restoration from the early warning event, the method further comprises at least one of: resuming traffic transmission; informing an upper layer of the restoration; and informing a control node of the restoration.

As an example, upon declaration of an RLF, when the fifth UE is a remote UE, a second relay reselection may be triggered. As a further example, the second relay reselection may be Sol #8.

As a further example, a discovery message transmitted by the fifth UE to at least a neighbor UE and/or a link establishment message transmitted by the fifth UE to at least the neighbor UE selected as a relay UE may include cause information about discovery and link establishment respectively.

As an example, upon declaration of an RLF, when the fifth UE is in RRC_INACTIVE, an RRC resume process may be performed to continue transmission over a control node, and when the fifth UE is in RRC_IDLE, an RRC setup process may be started.

As an example, an RLF may be declared for the link based on a second threshold of radio channel quality of the link. As a further example, the second threshold may be lower than the first threshold.

As an example, when the fifth UE is a source UE, a discovery process may be initiated with at least a neighbor UE based on a second threshold of radio channel quality of the link, without declaration of an RLF. As a further example, the second threshold may be lower than the first threshold.

As a further example, the second threshold may be preconfigured or configured by a control node for the fifth UE.

As a further example, when the fifth UE is associated with more than one link, the second threshold may be configured per link.

As an example, when the fifth UE is a remote UE, UE-to-UE relay reselection criteria provided by a control node to the fifth UE may include at least one of: a UE-to-UE relay load threshold; a signal strength threshold; a packet lost rate or a retransmission rate; packet latency; and a maximum data burst volume.

As an example, when the fifth UE is a remote UE, a control node may be informed of which UE-to-UE relay the fifth UE is connected to and/or which relay the fifth UE is able to reach.

As an example, the control node may be a gNB or a controlling UE; and/or the link may be an end to end connection comprising at least two hops.

FIG. 4F is a flow chart illustrating a method 460 implemented on a sixth terminal device according to some embodiments of the present disclosure. As an example, operations of this flow chart may be performed by a sixth UE which is one of the UEs to which the fifth UE transmit a first message about the early warning event at the block 452.

In one embodiment, the sixth UE may receive a first message about an early warning event from a fifth UE (block 461). The early warning event may be declared by the fifth UE for a link associated with the fifth UE based on a first threshold of radio channel quality of the link. By way of example, the first threshold may be preconfigured or configured by a control node for the fifth UE.

As an example, the first message may be received via at least one of: PC5-RRC signaling; MAC CE; a control PDU of a protocol layer; and L1 signaling.

As an example, the first message may contain at least one of: a warning cause; information indicating at least one hop associated with the early warning event and/or the fifth UE; and a time when the early warning event is detected.

As an example, upon reception of the first message, the method may further comprise at least one of: suspending part of traffic transmission; informing an upper layer of the early warning event; and informing a control node of the early warning event.

As a further example, when the sixth UE is in RRC_CONNECTED, the early warning event may be informed to the control node in an RRC message, and when the sixth UE is in RRC_INACTIVE, the early warning event may be informed to the control node by an RRC resume process.

As an example, after the link is restored from the early warning event, a second message about the restoration may be received from the fifth UE via at least one of: PC5-RRC signaling; MAC CE; a control PDU of a protocol layer; and L1 signaling.

As a further example, the second message may contain at least one of: a warning cause; information indicating at least one hop associated with the early warning event and/or at least the fifth UE; a time when the early warning event is detected; and a time when the link is restored.

As a further example, upon reception of the second message, the method may further comprise at least one of: resuming traffic transmission; informing an upper layer of the restoration; and informing a control node of the restoration.

As an example, when the fifth UE is a source UE which has declared an RLF, a discovery message transmitted by the fifth UE to the sixth UE may include cause information about discovery.

As a further example, when the sixth UE is selected as a relay UE, a link establishment message transmitted by the fifth UE to the sixth UE may include cause information about link establishment.

As a further example, the RLF associated with the discovery message may be declared by the fifth UE based on a second threshold of radio channel quality of the link. As a further example, the second threshold is lower than the first threshold.

As an example, when the fifth UE is a source UE which does not declare an RLF, a discovery message may be received from the fifth UE in a discovery process initiated based on a second threshold of radio channel quality of the link. As a further example, the second threshold is lower than the first threshold.

As a further example, the second threshold may be preconfigured or configured by a control node for the fifth UE.

As an example, the control node may be a gNB or a controlling UE; and/or the link may be an end to end connection comprising at least two hops.

FIG. 4G is a flow chart illustrating a method 470 implemented on a control node according to some embodiments of the present disclosure. As an example, operations of this flow chart may be performed by a gNB or a controlling UE.

In one embodiment, the control node may determine a first threshold of radio channel quality of a link for a fifth UE (block 471). The first threshold may be associated with an early warning event for the link. By way of example, when the fifth UE is associated with more than one link, the first threshold may be configured per link.

As an example, information about the early warning event may be received from the fifth UE or from a sixth UE which has received a first message about the early warning event.

As a further example, when the fifth UE or the sixth UE is in RRC_CONNECTED, the information about the early warning event may be received in an RRC message, and when the fifth UE or the sixth UE is in RRC_INACTIVE, the information about the early warning event may be received by an RRC resume process.

As an example, information about restoration from the early warning event may be received from the fifth UE or from a sixth UE which has received a first message about the early warning event.

As an example, an RRC resume request may be received from the fifth UE which is in RRC_INACTIVE and has declared an RLF.

As an example, a second threshold of radio channel quality of the link for the fifth UE may be determined. As a further example, the second threshold may be associated with an RLF for the link and lower than the first threshold.

As a further example, when the fifth UE is associated with more than one link, the second threshold may be configured per link.

As an example, UE-to-UE relay reselection criteria provided by the control node may include at least one of: a UE-to-UE relay load threshold; a signal strength threshold; a packet lost rate or a retransmission rate; packet latency; and a maximum data burst volume.

As an example, information about which UE-to-UE relay the fifth UE is connected to and/or which relays the fifth UE is able to reach may be received from the fifth UE.

As an example, the link may be an end to end connection comprising at least two hops.

FIG. 5 is a block diagram illustrating an apparatus 500 according to various embodiments of the present disclosure. As shown in FIG. 5, the apparatus 500 may comprise one or more processors such as processor 501 and one or more memories such as memory 502 storing computer program codes 503. The memory 502 may be non-transitory machine/processor/computer readable storage medium. In accordance with some exemplary embodiments, the apparatus 500 may be implemented as an integrated circuit chip or module that can be plugged or installed into a first terminal device as described with respect to FIG. 4A, a second terminal device as described with respect to FIG. 4B, a third terminal device as described with respect to FIG. 4C, or a communication device as described with respect to FIG. 4D. In such cases, the apparatus 500 may be implemented as a first terminal device as described with respect to FIG. 4A, a second terminal device as described with respect to FIG. 4B, a third terminal device as described with respect to FIG. 4C, or a communication device as described with respect to FIG. 4D.

In some implementations, the one or more memories 502 and the computer program codes 503 may be configured to, with the one or more processors 501, cause the apparatus 500 at least to perform any operation of the method as described in connection with FIG. 4A. In other implementations, the one or more memories 502 and the computer program codes 503 may be configured to, with the one or more processors 501, cause the apparatus 500 at least to perform any operation of the method as described in connection with FIG. 4B. In other implementations, the one or more memories 502 and the computer program codes 503 may be configured to, with the one or more processors 501, cause the apparatus 500 at least to perform any operation of the method as described in connection with FIG. 4C. In other implementations, the one or more memories 502 and the computer program codes 503 may be configured to, with the one or more processors 501, cause the apparatus 500 at least to perform any operation of the method as described in connection with FIG. 4D. Alternatively or additionally, the one or more memories 502 and the computer program codes 503 may be configured to, with the one or more processors 501, cause the apparatus 500 at least to perform more or less operations to implement the proposed methods according to the exemplary embodiments of the present disclosure.

FIG. 6A is a block diagram illustrating an apparatus 610 according to some embodiments of the present disclosure. As shown in FIG. 6A, the apparatus 610 may comprise a generating unit 611 and a transmitting unit 612. In an exemplary embodiment, the apparatus 610 may be implemented in a first terminal device such as a UE. The generating unit 611 may be operable to carry out the operation in block 412, and the transmitting unit 612 may be operable to carry out the operation in block 414. Optionally, the generating unit 611 and/or the transmitting unit 612 may be operable to carry out more or less operations to implement the proposed methods according to the exemplary embodiments of the present disclosure.

FIG. 6B is a block diagram illustrating an apparatus 620 according to some embodiments of the present disclosure. As shown in FIG. 6B, the apparatus 620 may comprise a receiving unit 621 and a determining unit 622. In an exemplary embodiment, the apparatus 620 may be implemented in a second terminal device such as a UE. The receiving unit 621 may be operable to carry out the operation in block 422, and the determining unit 622 may be operable to carry out the operation in block 424. Optionally, the receiving unit 621 and/or the determining unit 622 may be operable to carry out more or less operations to implement the proposed methods according to the exemplary embodiments of the present disclosure.

FIG. 6C is a block diagram illustrating an apparatus 630 according to some embodiments of the present disclosure. As shown in FIG. 6C, the apparatus 630 may comprise a receiving unit 631 and a determining unit 632. In an exemplary embodiment, the apparatus 630 may be implemented in a third terminal device such as a UE. The receiving unit 631 may be operable to carry out the operation in block 432, and the determining unit 632 may be operable to carry out the operation in block 434. Optionally, the receiving unit 631 and/or the determining unit 632 may be operable to carry out more or less operations to implement the proposed methods according to the exemplary embodiments of the present disclosure.

FIG. 6D is a block diagram illustrating an apparatus 640 according to some embodiments of the present disclosure. As shown in FIG. 6D, the apparatus 640 may comprise a determining unit 641 and a transmitting unit 642. In an exemplary embodiment, the apparatus 640 may be implemented in a communication device such as a base station or a UE. The determining unit 641 may be operable to carry out the operation in block 442, and the transmitting unit 642 may be operable to carry out the operation in block 444. Optionally, the determining unit 641 and/or the transmitting unit 642 may be operable to carry out more or less operations to implement the proposed methods according to the exemplary embodiments of the present disclosure.

FIG. 6E is a block diagram illustrating a fifth terminal device 650 according to some embodiments of the present disclosure. As an example, the fifth terminal device 650 may act as a fifth UE which has detected early warning of the link, but it is not limited thereto. It should be appreciated that the fifth terminal device 650 may be implemented using components other than those illustrated in FIG. 6E.

With reference to FIG. 6E, the fifth terminal device 650 may comprise at least a processor 651, a memory 652, a network interface 653 and a communication medium 654. The processor 651, the memory 652 and the network interface 653 may be communicatively coupled to each other via the communication medium 654.

The processor 651 may include one or more processing units. A processing unit may be a physical device or article of manufacture comprising one or more integrated circuits that read data and instructions from computer readable media, such as the memory 652, and selectively execute the instructions. In various embodiments, the processor 651 may be implemented in various ways. As an example, the processor 651 may be implemented as one or more processing cores. As another example, the processor 651 may comprise one or more separate microprocessors. In yet another example, the processor 651 may comprise an application-specific integrated circuit (ASIC) that provides specific functionality. In still another example, the processor 651 may provide specific functionality by using an ASIC and/or by executing computer-executable instructions.

The memory 652 may include one or more computer-usable or computer-readable storage medium capable of storing data and/or computer-executable instructions. It should be appreciated that the storage medium is preferably a non-transitory storage medium.

The network interface 653 may be a device or article of manufacture that enables the fifth terminal 650 to send data to or receive data from other devices. In different embodiments, the network interface 653 may be implemented in different ways. As an example, the network interface 653 may be implemented as an Ethernet interface, a token-ring network interface, a fiber optic network interface, a network interface (e.g., Wi-Fi, WiMax, etc.), or another type of network interface.

The communication medium 654 may facilitate communication among the processor 651, the memory 652 and the network interface 653. The communication medium 654 may be implemented in various ways. For example, the communication medium 654 may comprise a Peripheral Component Interconnect (PCI) bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium.

In the example of FIG. 6E, the instructions stored in the memory 652 may include those that, when executed by the processor 651, cause the fifth terminal device 650 to implement the method described with respect to FIG. 4E.

FIG. 6F is another block diagram illustrating a fifth terminal device 660 according to some embodiments of the present disclosure. As an example, the fifth terminal device 660 may act as a fifth UE which has detected early warning of the link, but it is not limited thereto. It should be appreciated that the fifth terminal device 660 may be implemented using components other than those illustrated in FIG. 6F.

With reference to FIG. 6F, the fifth terminal device 660 may comprise at least a declaration unit 661 and a transmission unit 662. The declaration unit 661 may be adapted to perform at least the operation described in the block 451 of FIG. 4E. The transmission unit 662 may be adapted to perform at least the operation described in the block 452 of FIG. 4E.

FIG. 6G is a block diagram illustrating a sixth terminal device 670 according to some embodiments of the present disclosure. As an example, the sixth terminal device 670 may act as a sixth UE which is one of the UEs to which the fifth UE transmit a first message about the early warning event. It should be appreciated that the sixth terminal device 670 may be implemented using components other than those illustrated in FIG. 6G.

With reference to FIG. 6G, the sixth terminal device 670 may comprise at least a processor 671, a memory 672, a network interface 673 and a communication medium 674. The processor 671, the memory 672 and the network interface 673 are communicatively coupled to each other via the communication medium 674.

The processor 671, the memory 672, the network interface 673 and the communication medium 674 are structurally similar to the processor 651, the memory 652, the network interface 653 and the communication medium 654 respectively, and will not be described herein in detail.

In the example of FIG. 6G, the instructions stored in the memory 672 may include those that, when executed by the processor 671, cause the sixth terminal device 670 to implement the method described with respect to FIG. 4F.

FIG. 6H is another block diagram illustrating a sixth terminal device 680 according to some embodiments of the present disclosure. As an example, the sixth terminal device 680 may act as a sixth UE which is one of the UEs to which the fifth UE transmit a first message about the early warning event. It should be appreciated that the sixth terminal device 680 may be implemented using components other than those illustrated in FIG. 6H.

With reference to FIG. 6H, the sixth terminal device 680 may comprise at least a receiving unit 681. The receiving unit 681 may be adapted to perform at least the operation described in the block 461 of FIG. 4F.

FIG. 6I is a block diagram illustrating a control node 690 according to some embodiments of the present disclosure. As an example, the control node 690 may act as a gNB or a controlling UE. It should be appreciated that the control node 690 may be implemented using components other than those illustrated in FIG. 6I.

With reference to FIG. 6I, the control device 690 may comprise at least a processor 691, a memory 692, a network interface 693 and a communication medium 694. The processor 691, the memory 692 and the network interface 693 are communicatively coupled to each other via the communication medium 694.

The processor 691, the memory 692, the network interface 693 and the communication medium 694 are structurally similar to the processor 651 or 671, the memory 652 or 672, the network interface 653 or 673 and the communication medium 654 or 674 respectively, and will not be described herein in detail.

In the example of FIG. 6I, the instructions stored in the memory 692 may include those that, when executed by the processor 691, cause the control node 690 to implement the method described with respect to FIG. 4G.

FIG. 6J is another block diagram illustrating a control node 6100 according to some embodiments of the present disclosure. As an example, the control node 6100 may act as a gNB or a controlling UE. It should be appreciated that the control node 6100 may be implemented using components other than those illustrated in FIG. 6J.

With reference to FIG. 6J, the control node 6100 may comprise at least a determination unit 6101. The determination unit 6101 may be adapted to perform at least the operation described in the block 471 of FIG. 4G.

The units shown in FIGS. 6F, 6H and 6J may constitute machine-executable instructions embodied within a machine, e.g., readable medium, which when executed by a machine will cause the machine to perform the operations described. Besides, any of these units may be implemented as hardware, such as an application specific integrated circuit (ASIC), Digital Signal Processor (DSP), Field Programmable Gate Array (FPGA) or the like.

Moreover, it should be appreciated that the arrangements described herein are set forth only as examples. Other arrangements (e.g., more controllers or more detectors, etc.) may be used in addition to or instead of those shown, and some units may be omitted altogether. Functionality and cooperation of these units are correspondingly described in more detail with reference to FIGS. 4E-4G.

FIG. 6K is a block diagram illustrating a wireless communication system 6110 according to some embodiments of the present disclosure. The wireless communication system 6110 comprises at least a fifth terminal device 6111, a sixth terminal device 6112 and a control node 6113. In one embodiment, the fifth terminal device 6111 may act as the fifth terminal device 650 or 660 as depicted in FIG. 6E or 6F, the sixth terminal device 6112 may act as the sixth terminal device 670 or 680 as depicted in FIG. 6G or 6H, and the control node 6113 may act as the control node 690 or 6100 as depicted in FIG. 6I or 6J. In one embodiment, the fifth terminal device 6111, the sixth terminal device 6112 and the control node 6113 may communicate with each other.

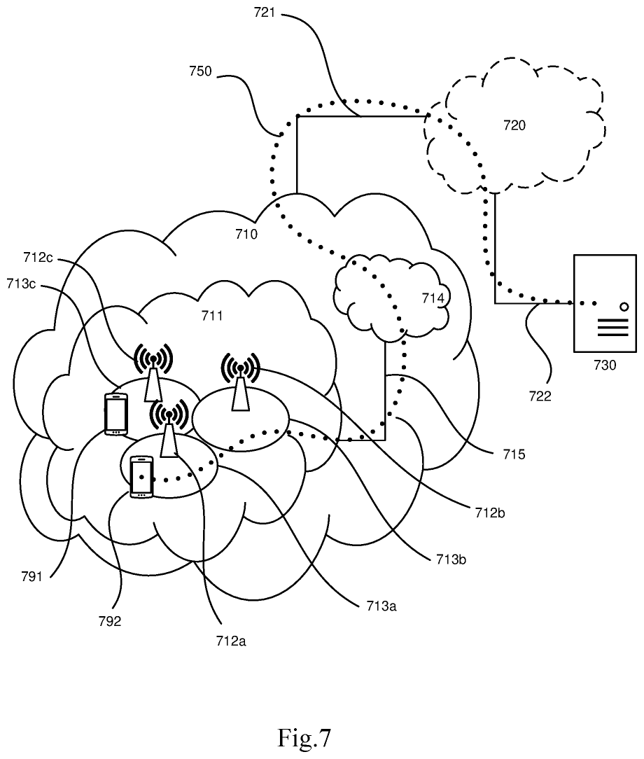

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

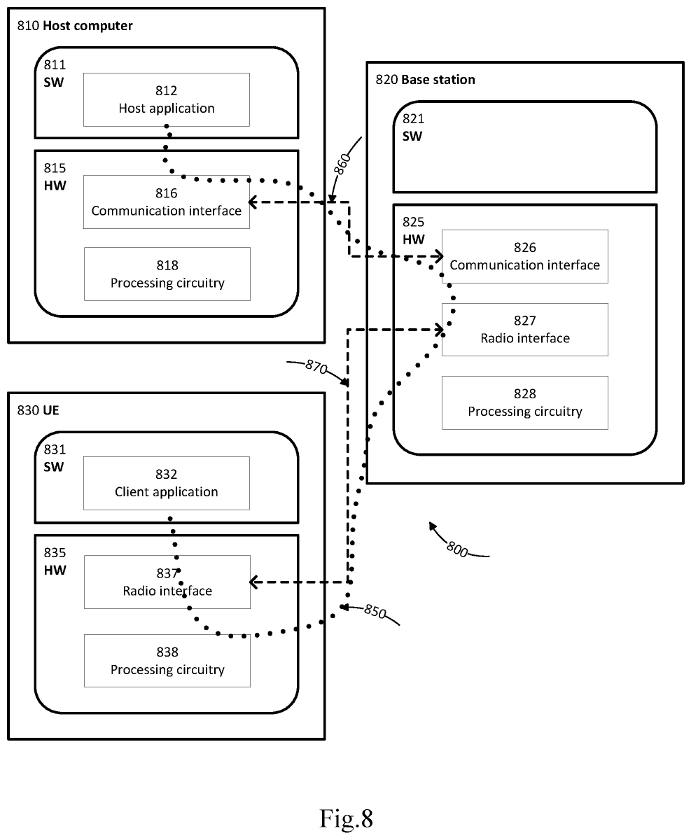

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

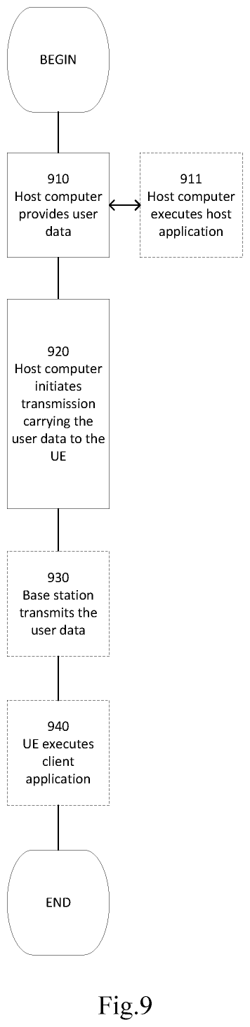

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

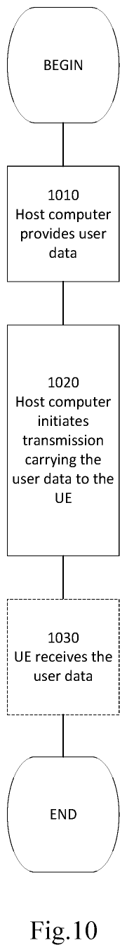

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

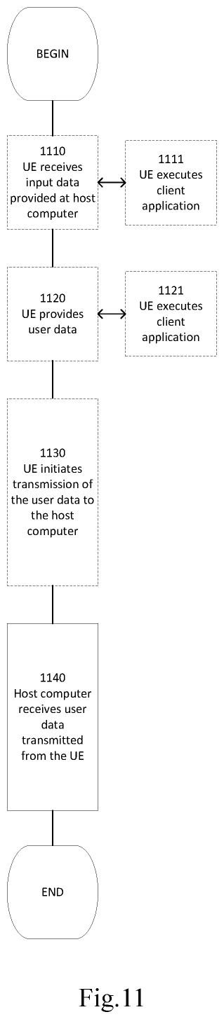

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

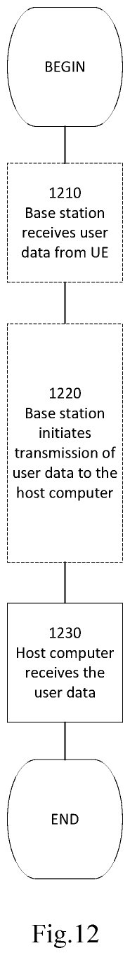

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 440 as describe with respect to FIG. 4D or any step of the exemplary method 470 as describe with respect to FIG. 4G.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 440 as describe with respect to FIG. 4D or any step of the exemplary method 470 as describe with respect to FIG. 4G.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 410 as describe with respect to FIG. 4A, or any step of the exemplary method 420 as describe with respect to FIG. 4B, or any step of the exemplary method 430 as describe with respect to FIG. 4C, or any step of the exemplary method 440 as describe with respect to FIG. 4D, or any step of the exemplary method 450 as describe with respect to FIG. 4E, or any step of the exemplary method 460 as describe with respect to FIG. 4F, or any step of the exemplary method 470 as describe with respect to FIG. 4G.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 410 as describe with respect to FIG. 4A, or any step of the exemplary method 420 as describe with respect to FIG. 4B, or any step of the exemplary method 430 as describe with respect to FIG. 4C, or any step of the exemplary method 440 as describe with respect to FIG. 4D, or any step of the exemplary method 450 as describe with respect to FIG. 4E, or any step of the exemplary method 460 as describe with respect to FIG. 4F, or any step of the exemplary method 470 as describe with respect to FIG. 4G.

According to some exemplary embodiments, there is provided a method implemented in a communication system which may include a host computer, a base station and a UE. The method may comprise, at the host computer, receiving user data transmitted to the base station from the UE which may perform any step of the exemplary method 410 as describe with respect to FIG. 4A, or any step of the exemplary method 420 as describe with respect to FIG. 4B, or any step of the exemplary method 430 as describe with respect to FIG. 4C, or any step of the exemplary method 440 as describe with respect to FIG. 4D, or any step of the exemplary method 450 as describe with respect to FIG. 4E, or any step of the exemplary method 460 as describe with respect to FIG. 4F, or any step of the exemplary method 470 as describe with respect to FIG. 4G.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 410 as describe with respect to FIG. 4A, or any step of the exemplary method 420 as describe with respect to FIG. 4B, or any step of the exemplary method 430 as describe with respect to FIG. 4C, or any step of the exemplary method 440 as describe with respect to FIG. 4D, or any step of the exemplary method 450 as describe with respect to FIG. 4E, or any step of the exemplary method 460 as describe with respect to FIG. 4F, or any step of the exemplary method 470 as describe with respect to FIG. 4G.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 440 as describe with respect to FIG. 4D or any step of the exemplary method 470 as describe with respect to FIG. 4G.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 440 as describe with respect to FIG. 4D or any step of the exemplary method 470 as describe with respect to FIG. 4G.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1. A method performed by a first terminal device, comprising:
generating a message targeting at least a second terminal device, wherein the message includes an indicator used to determine which of the first terminal device and the second terminal device is to perform relay selection or reselection; and
transmitting the message towards the second terminal device.

2. The method of claim 1, wherein the indicator is an identifier of the first terminal device or a time stamp representing a time when the first terminal device requests the relay selection or reselection.

3. The method of claim 2, wherein it is determined that the second terminal device is to perform the relay selection or reselection, when one of the following occurs:
the time stamp indicates that the first terminal device requests the relay selection or reselection earlier than the second terminal device;
the identifier of the first terminal device is larger than an identifier of the second terminal device; and
the identifier of the first terminal device is smaller than the identifier of the second terminal device.

4. The method of claim 1, further comprising:
receiving a response to the message from the second terminal device, wherein the response to the message includes a result of the relay selection or reselection performed by the second terminal device.

5. The method of claim 1, further comprising:
starting a timer, in response to transmitting the message towards the second terminal device.

6. The method of claim 5, wherein when the response to the message is not received by the first terminal device until the timer is expired, the method further comprises:
performing the relay selection or reselection; and
transmitting a result of the relay selection or reselection performed by the first terminal device to the second terminal device.

7. The method of claim 1, further comprising:
performing a negotiation with the second terminal device to determine a criterion for determining which of the first terminal device and the second terminal device is to perform the relay selection or reselection.

8. The method of claim 1, further comprising:
transmitting a notification to one or more devices on a path between the first terminal device and the second terminal device, wherein the one or more devices include at least the second terminal device, and the notification indicates that the first terminal device triggers a relay selection or reselection event.

9. The method of claim 8, further comprising:
handling the relay selection or reselection event during a time period, wherein the one or more devices do not trigger the relay selection or reselection event during the time period.

10. The method of claim 8, wherein the relay selection or reselection event is triggered by the first terminal device according to a threshold, and wherein the threshold is different from respective thresholds configured for the one or more devices to trigger the relay selection or reselection event.

11. The method of claim 1, further comprising:
receiving configuration information for the relay selection or reselection from a base station and/or a fourth terminal device.

12-14. (canceled)

15. A method performed by a second terminal device, comprising:
receiving a message targeting at least the second terminal device from a first terminal device, wherein the message includes an indicator used to determine which of the first terminal device and the second terminal device is to perform relay selection or reselection; and
determining whether to perform the relay selection or reselection, according to the indicator.

16-27. (canceled)

28. A method performed by a third terminal device, comprising:
receiving a first message targeting at least a second terminal device from a first terminal device, wherein the first message includes a first indicator used to determine which of the first terminal device and the second terminal device is to perform relay selection or reselection; and
determining whether to forward the first message towards the second terminal device, based at least in part on the first indicator.

29. (canceled)

30. The method of claim 28, further comprising:
receiving a second message targeting at least the first terminal device from the second terminal device, wherein the second message includes a second time stamp representing a time when the second terminal device requests the relay selection or reselection; and
comparing the first time stamp and the second time stamp to determine whether the first terminal device requests the relay selection or reselection earlier than the second terminal device.

31. (canceled)

32. The method of claim 28, wherein the first indicator is an identifier of the first terminal device.

33. The method of claim 32, further comprising:
receiving a second message targeting at least the first terminal device from the second terminal device, wherein the second message includes an identifier of the second terminal device; and
comparing the identifiers of the first terminal device and the second terminal devices.

34-35. (canceled)

36. The method of claim 30, wherein when the third terminal device determines to forward the first message towards the second terminal device, the method further comprises:
forwarding the first message towards the second terminal device, without forwarding the second message towards the first terminal device.

37. The method of claim 36, further comprising:
receiving a response to the first message from the second terminal device, wherein the response to the first message includes a result of the relay selection or reselection performed by the second terminal device; and
forwarding the response to the first message to the first terminal device.

38. The method of claim 30, wherein when the third terminal device determines not to forward the first message towards the second terminal device, the method further comprises:
forwarding the second message towards the first terminal device.

39. The method of claim 38, further comprising:
receiving a response to the second message from the first terminal device, wherein the response to the second message includes a result of the relay selection or reselection performed by the first terminal device; and
forwarding the response to the second message to the second terminal device.

40-79. (canceled)
